(19) United States
(12) Patent Application Publication
(10) Pub. No.: US 2023/0161159 A1
(43) Pub. Date: May 25, 2023

(54) OPTICAL SYSTEM OF AUGMENTED REALITY HEAD-UP DISPLAY DEVICE WITH IMPROVED VISUAL ERGONOMICS

(71) Applicant: WAYRAY AG, Zürich (CH)

(72) Inventors: Andrey BELKIN, Zürich (CH); Kseniia Igorevna LVOVA, Moscow (RU); Vitaly PONOMAREV, Zürich (CH); Anton SHCHERBINA, Zürich (CH); Mikhail SVARYCHEUSKI, Zürich (CH)

(73) Assignee: WAYRAY AG, Zürich (CH)

(21) Appl. No.: 17/546,393

(22) Filed: Dec. 9, 2021

(30) Foreign Application Priority Data
Nov. 22, 2021 (GB) 2116785.3

(51) Int. Cl. G02B 27/01; G02B 27/00

(52) U.S. Cl. CPC G02B 27/0172; G02B 27/0025; G02B 2027/0174

(57) ABSTRACT

Disclosed embodiments are related to an optical system of an augmented reality (AR) head-up display (HUD) devices. The implementation of disclosed optical system in AR HUD devices improves visual ergonomics by providing enhanced stereoscopic depth of field (SDoF). The SDoF is created by the formation of a proper shape and spatial orientation of a virtual image surface (VIS) where a convex side is oriented towards a user or observer. When such optical systems of AR HUD devices are implemented in a vehicle, the improved visual ergonomics provides improved driving comfort and safety.

### RELATED APPLICATIONS

The present application claims priority to United Kingdom Patent Application No. 2116785.3 filed on Nov. 22, 2021, the contents of which is hereby incorporated by reference in its entirety.

### FIELD

Embodiments discussed herein are generally related to optics, head-up display (HUDs), and augmented reality (AR) systems, and in particular, to configurations and arrangements of optical elements and devices to enhance and/or improve visual ergonomics by improving stereoscopic depth of field.

### BACKGROUND

A Head-Up Display (HUD) is a transparent display that presents information without requiring a viewer to look away from their viewpoint. Typical HUDs include a combiner, a light projection device (referred to as a “projector” or “projection unit”), and a video/image generation computer device. The combiner is usually a piece of glass located directly in front of the viewer, that redirects the projected image from projector in such a way as to see the real world surroundings and the projected virtual image at the same time. The projector is often an optical unit including a lens or mirror with a cathode-ray tube, light emitting diode (LED) display, or liquid crystal display (LCD) that produces an image. However, these classical HUDs often produce optical aberrations, and multiple mirrors or lenses are required to correct for these aberrations. Holographic HUDs (hHUDs) typically include a laser projector and a holographic optical element (HOE) as a combiner. Some hHUDs place the HOE inside a display screen, such as a windscreen or windshield of an automobile or aircraft.

When implemented in vehicles such as automobiles or aircraft, HUDs can reduce the duration and frequency of vehicle operators looking away from the windscreen. However, HUD-based augmented reality (AR) applications are limited in part due to narrow FoV and fixed virtual-image distance. These limitations make it difficult to match or otherwise project virtual images to relevant real objects.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings:

FIG. 1a depicts a vertical section of an example augmented reality (AR) head-up display (HUD) system according to various embodiments. FIG. 1b depicts a horizontal section of the AR HUD system of FIG. 1a. FIG. 2 depicts another example AR HUD system according to various embodiments.

FIG. 3 depicts a field of view (FoV) and a stereoscopic depth of field (SDoF) of a HUD showing an eye box in relation to the virtual image. FIG. 4 depicts vertical and horizontal sections of a virtual image surface (VIS) according to various embodiments. FIG. 5 depicts an example implementation of the vertical and horizontal sections of the VIS of FIG. 4.

FIG. 6 depicts a comparison between AR HUD optical systems. FIG. 7 depicts a graph showing a comparison of sags of the AR HUD optical systems of FIG. 6. FIGS. 8 and 9 show example VIS shapes for different driving scenarios. FIG. 10 depicts an example partitioning scheme for the horizontal FoV for a natural perspective according to various embodiments.

FIGS. 11, 12, and 13 depict various aspects of stereoscopic depth of field (SDoF). FIG. 14 depicts limitations on a size of a vertical field of view of a typical AR HUD. FIG. 15 depicts a graph showing the dependence of the volume of a typical AR HUD from the optical power of the combiner for the different distances to the virtual image.

### DETAILED DESCRIPTION

The present disclosure describes various configurations and arrangements of optical elements for augmented reality (AR) systems such as head-up displays (HUDs), and/or holographic HUDs (hHUDs). The embodiments herein improve visual ergonomics by providing SDoF. This stereoscopic depth of field (SDoF) is created by a shape and orientation of a virtual image surface (VIS) in the AR system. Configurations and arrangements of various optical elements of AR systems, as discussed infra, provide the shape and orientation of a VIS that creates the SDoF. When such AR systems are HUDs or hHUDs (collectively referred to as “(h)HUDs”) implemented in a vehicle, the improved visual ergonomics provides improved driving comfort and safety.

A first conventional HUD, such as those discussed in U.S. Pat. No. 10,814,723, achieves SDoF by the tilt of a VIS in the direction of the vertical field of view (FoV), and thus, virtual objects at the lower area of the FoV appear to be closer than virtual objects at the upper area of the FoV. In other words, the first conventional HUD provides the SDoF in the direction of the vertical FoV, which tend to be significantly narrower (at least twofold) than horizontal FoV. Further, a narrow vertical FoV limits the ability to provide sufficient SDoF for enabling significant improvements in visual ergonomics. Moreover, the difficulty in significant improvement of the SDoF in the first conventional HUD, while keeping unchanged the usable size of the virtual object, which does not exceed the stereothreshold (i.e., is not perceived by an observer as inclined), is caused by limitations on the vertical size of the FoV.

A second conventional HUD, such as those discussed in JP App. No. 2017227681, achieves SDoF by formation of the VIS having a curved shape. However, a convex side of the curved shape is oriented away from the observer. In the second conventional HUD, the virtual objects in the central area of the FoV appear to be farther than the virtual objects on the side areas of the FoV. This limitation of visual ergonomics leads to drawbacks in driving comfort and driving safety, and is caused by the curved VIS spatial orientation described previously. Thus, the elements of the virtual interface, which appear on the side parts of the VIS and show virtual objects of driving direction (e.g., navigation arrows or other graphical elements/objects), misalign with the natural perception of the real driving direction viewed by the observer. Additionally, there is a risk that the central part of the VIS will either intersect a moving vehicle ahead of the ego vehicle, or will be in front of a moving vehicle ahead of the ego vehicle, which can negatively affect the comfort of visual perception of the virtual interface elements.

Furthermore, the previously mentioned spatial orientation of the VIS of the second conventional HUD provides an inverted perspective of the virtual objects' representation. This means that virtual objects appearing farther away from the observer will have a larger angular size than virtual objects appearing closer to the observer, which is inconsistent with the natural perception of three-dimensional (3D) space. Moreover, increasing the SDoF of the second conventional HUD would be difficult because of the limitations on the size of the FoV caused by intrinsic properties of the optical system. Here, an increase in the FoV size would also affect the system size.

The main disadvantages of the conventional HUDs, such as those discussed previously, is limited visual ergonomics. The limited visual ergonomics is related to the insufficient value of provided SDoF. The ability to increase the SDoF in the conventional HUDs is limited by the size of the FoV and the usable size of the virtual object that is not perceived as inclined. The limited visual ergonomics lead to drawbacks in driving comfort and driving safety. These drawbacks are caused by the virtual image shape having its convex side oriented away from the observer.

The optical systems/devices discussed herein improve visual ergonomics in comparison with conventional HUDs. In particular, the optical systems/devices discussed herein provide a larger SDoF compared to conventional HUDs. This larger SDoF is provided by a proper shape and spatial orientation of the VIS, which allows alignment of displayed virtual objects (e.g., objects/images generated by the HUD system) with a real objects (e.g., objects viewed through the vehicle's windshield). The proper shape and spatial orientation of the VIS also reduces the possibility of the central area of the VIS intersecting with vehicles traveling ahead of the ego vehicle. In these ways, the optical systems/devices discussed herein improve comfort and safety while operating a vehicle.

A first implementation includes an optical system of an AR HUD, which is configured to generate a three-dimensional (3D) virtual image. The optical system comprises a picture generation unit (PGU), a combiner, and a corrector disposed between the PGU and the combiner. The corrector is implemented as a combination of optical surfaces. The optical surfaces include refracting surfaces, reflecting surfaces, or both refracting and reflecting surfaces. A curved VIS is formed as a result of the interaction of the PGU, the corrector, and the combiner. To improve visual ergonomics of the optical system (e.g., driving comfort and safety) by means of aligning one or more real images with one or more displayed virtual images, and increasing the SDoF, the combiner is implemented as a holographic optical element with a positive optical power, and the corrector comprises at least one rotationally asymmetric optical surface to monotonically increase of the optical path length from the center of the FoV in the direction of a horizontal FoV for the rays propagating from the PGU to the combiner. In these ways, a cylindrically shaped VIS is formed having a convex side oriented towards an observer, and its directrix is a continuous curved line, which is located along the direction of the horizontal FoV (HFoV) and/or extends in the direction of the HFoV. This allows virtual objects displayed in the central area of the FoV to appear to be closer than the virtual objects displayed on the side portions of the FoV.

A second implementation includes the optical system of the first implementation, wherein the corrector creates an optical path length that monotonically increases from the center of the FoV in the direction of the horizontal FoV for the rays propagating from the PGU to the combiner to form a VIS in a way that an angle between an arbitrary chief ray, aimed along the direction of the horizontal FoV, and a normal to the VIS, increases as the arbitrary chief ray becomes farther from the center of the FoV. This implementation increases the visual perception quality by imaging virtual objects in the display FoV in accordance with natural perspective.

A third implementation includes the optical system of the first and second implementations, wherein the corrector comprises at least one prism including at least one reflecting optical surface located between at least two refracting optical surfaces.

A fourth implementation includes the optical system of the first, second, and third implementations, wherein the one or more real images include a real driving direction and the one or more displayed virtual images includes a displayed virtual driving direction aligned with the real driving direction. As an example, the displayed virtual driving direction may be turn-by-turn (TBT) pointers, turn arrows, or other like graphical elements of a TBT navigation service.

### 1. Optical System of Augmented Reality Head-Up Display Device Arrangements and Configurations

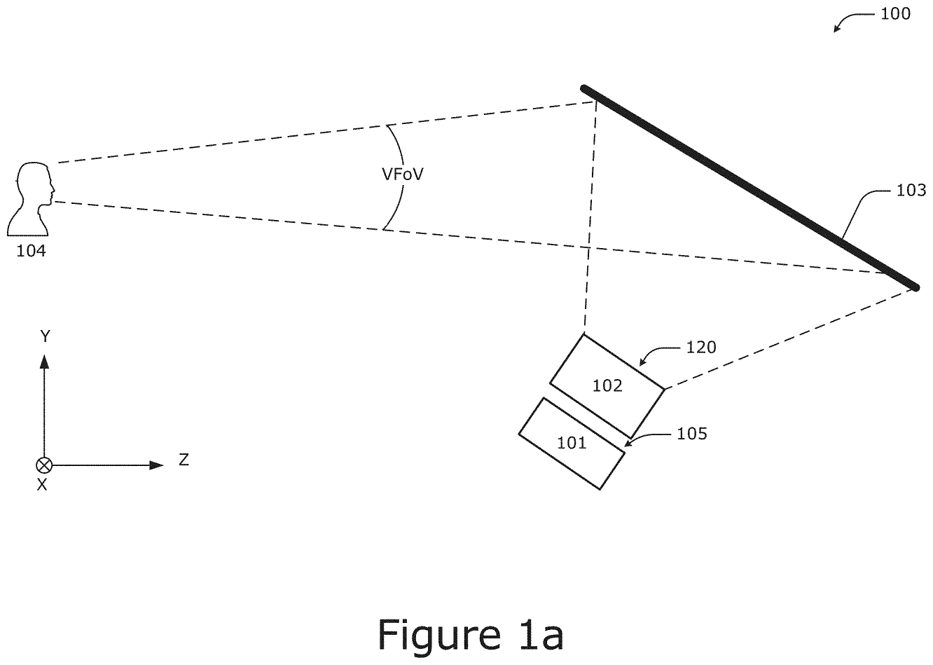

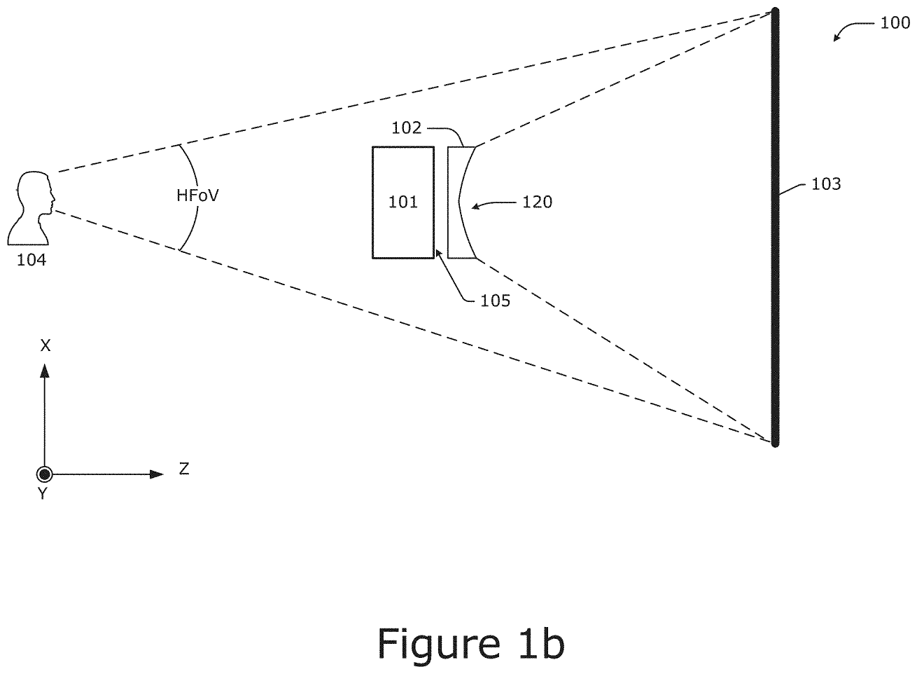

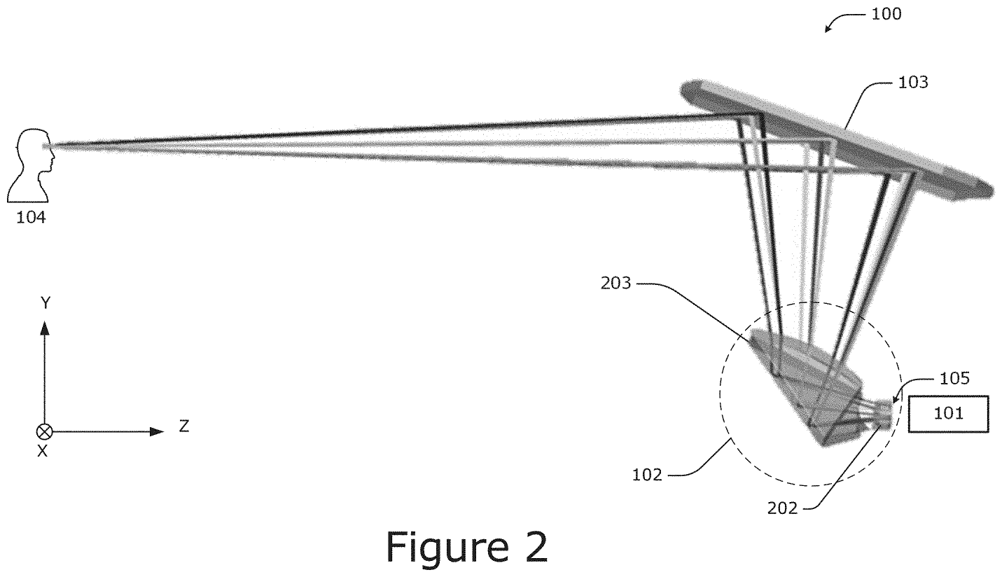

FIG. 1a depicts a side view of a head-up display (HUD) system 100 (or “HUD 100”), and FIG. 1b depicts a top view of the HUD 100 according to various embodiments. In particular, FIG. 1a shows a vertical section of the relative positions and interactions of the elements of the HUD 100. The “vertical section” refers to the plane in which the rays forming the vertical FoV are located. Furthermore, FIG. 1b shows a horizontal section of the relative positions and interaction of the elements of the HUD 100. The “horizontal section” refers to the plane in which the rays forming the horizontal FoV are located.

In some implementations, the HUD 100 is, or is part of, an augmented reality (AR) system, and as such, the HUD 100 may be referred to as an “AR HUD 100” or the like. The HUD 100 includes a picture generation unit (PGU) 101, correction optics assembly 102 (also referred to as “corrector 102”, “corrective optics 102”, and/or the like), and a combiner 103.

As examples, the PGU 101 may be implemented as a liquid-crystal display (LCD) projector, an LCD with laser illumination, a light emitting diode (LED) projector, laser diode projector, digital light processing (DLP) projector, a projector based on a digital micromirror device (DMD), liquid crystal on silicon (LCOS) with laser illumination, micro-electro-mechanical system (MEMS) with laser scanning, a microoptoelectromechanical system (MOEMS) laser scanner, and/or any other suitable device (or combination of devices). The PGU 101 also may include a diffusing element 105 (also referred to as “diffuser screen 105”, “diffusing surface 105”, “microlens array 105”, and/or the like) in some implementations.

The PGU 101 may include, or be communicatively coupled with a computer device and/or a controller. The computer device/controller includes one or more electronic elements that create/generate digital content to be displayed by the HUD 100, and provide suitable signaling to the PGU 101 to generate and project light rays representing the digital content to be displayed on the combiner 103. The digital content (e.g., text, images, video, etc.) may be stored locally, streamed from one or more remote devices via communication circuitry, and/or based on outputs from various sensors, electronic control units (ECUs), and/or actuators disposed in or on a vehicle. The content to be displayed may include, for example, safety messages (e.g., collision warnings, emergency warnings, pre-crash warnings, traffic warnings, and the like), Short Message Service (SMS)/Multimedia Messaging Service (MMS) messages, navigation system information (e.g., maps, turn-by-turn indicator arrows), movies, television shows, video game images, sensor information (e.g., speed, distance traveled, etc.), and/or other like information. The computer device and/or a controller may be, or may include, any suitable processing element(s) such as one or more of a microcontroller, microprocessor, application processor or central processing unit (CPU), graphics processing unit (GPU), ECU, digital signal processor (DSP), programmable logic device (PLD), field-programmable gate array (FPGA), Application Specific Integrated Circuit (ASIC), system on chip (SoC), a special-purpose processor specifically built and configurable to control the PGU 101, and/or combination(s) thereof. This element is now shown for simplicity of illustration and discussion, and so as not to obscure the disclosure the illustrated embodiments.

The combiner 103 in this example is a (semi-)transparent display surface located directly in front of a viewer 104 that redirects a projected virtual image from the PGU 101 in such a way as to allow the viewer 104 to view inside an FoV the real world surrounding and the virtual image at the same time thereby facilitating AR. Usually, the size of the FoV is defined by the largest optical element of a HUD, which is usually a combiner element such as combiner 103. In some implementations, the combiner is a large reflecting surface or other like display surface. In some implementations, the combiner 103 includes a holographic optical element (HOE) in or on the surface of the combiner 103, which redirects images/objects. In these implementations, the HUD 100 may be referred to as a holographic HUD (hHUD) or the like. In one example implementation, the combiner 103 is implemented as an HOE having an optical power in the range of 1.1-6.6 diopters, formed on a photopolymer substrate. The substrate can be placed either on the inner side of a windshield/windscreen or integrated into the windshield/windscreen during a triplex manufacturing process and/or some other fabrication means. The combiner 103 and the HOE may be formed of any suitable materials and/or material composites such as, for example, one or more of glass, plastic(s), polymer(s), and/or other similar material and/or variants thereof. The HOE in or on the combiner 103 may have a certain arrangement work together with the other optical elements of the HUD 100 to display images appearing far ahead of the observer 104.

The corrector 102 (also referred to as “corrective optics 102” or “auxiliary optics 102”) works together with the combiner 103 to display the virtual images. The corrector 102 may be configured to correct aberrations caused by the combiner 103. In various implementations, the corrector 102 is placed between the PGU 101 and the combiner 103. The corrector 102 may include one or more optical element such as, for example, lenses, prisms, mirrors, HOEs, prismatic lenses, and/or other optical elements, and/or combinations thereof. In this example, the corrector 102 includes a rotationally asymmetric surface 120 that faces one side of the combiner 103. The rotationally asymmetric surface 120 is a surface without rotational symmetry. As discussed in more detail infra, the rotationally asymmetric surface 120 enables the corrector 102 to provide a monotonically increasing optical path length from the center of FoV, thereby providing the curved VIS after corrected light rays reach the combiner 103. The combiner 103 redirects the light rays into the eye box 104 allowing the observer 104 to view virtual images displayed at different distances from the eye box 104.

In one example, the corrector 102 is implemented as one or more refracting optical surfaces, one or more reflecting optical surfaces, or some combination of at least one refracting optical surface and at least one reflecting optical surface. Any of these optical surfaces may have spherical, aspherical, toroidal, or freeform shapes. The properties of the corrector 102 are dependent on the particular arrangement and configuration of various optical elements of the HUD 100 within a particular environment (e.g., within an automobile cabin, aircraft cockpit, etc.). For example, the corrector 102 may have a first set of properties when the HUD 100 is configured or deployed within an automobile and may have a second set of properties when the HUD 100 is configured or deployed within an aircraft cockpit. In another example, the corrector 102 may have a first set of properties when the HUD 100 is configured or deployed within a first automobile of a first make and model, and may have a first set of properties when the HUD 100 is configured or deployed within a second automobile of a second make and model. The set of properties include, for example, the surface types or patterns of the corrector 102, a shape formed by the surfaces of the corrector 102, a size of the corrector 102, a position of the corrector 102 with respect to at least one other optical element, an orientation of the corrector 102 with respect to at least one other optical element, materials or substances used to make the corrector 102, and/or other properties.

FIG. 2 depicts another view of the relative positions and interactions of the elements of HUD 100 according to various embodiments. In FIG. 2, like-numbered elements are the same as those discussed previously. FIG. 2 also shows some elements of the correction optics assembly 102 including optical elements 202 and 203.

The optical element 202 can be can be formed into any type of three-dimensional shape comprising at least one rotationally asymmetric optical surface and one or more additional optical surfaces including flat or planar, spherical, aspherical, cylindrical, toroidal, biconic, freeform, and/or any suitable type of surface or combinations thereof. The at least one rotationally asymmetric optical surface may have any type of surface design or geometry, such as those listed herein, so long as that surface type/design/geometry is not rotationally symmetrical. Additionally, in implementations where there are more than one additional optical surface, these additional optical surfaces may be the same or different from the other additional optical surfaces (e.g., a first additional optical surface may be an aspherical surface and a second additional optical surface may be a free form surface). Additionally or alternatively, one or more of the additional optical surfaces may have the same surface design/geometry as the at least one rotationally asymmetric optical surface. Furthermore, individual surfaces of the optical element 203 can be spherical, aspherical, anamorphic, cylindrical, freeform, and/or any suitable type of surface or combinations thereof. In implementations that include freeform surfaces, the freeform surfaces may be modeled and/or formed based on mathematical descriptions. Examples of such mathematical descriptions include radial basis functions, basis splines, non-uniform rational basis splines (NURBS), orthogonal polynomials (e.g., Zernike polynomials, Q-type polynomials, φ-polynomial, etc.), non-orthogonal bases (e.g., -X-Y polynomials), Chebyshev polynomials, Legendre polynomials, hybrid stitched representations, and/or combinations thereof.

In some implementations, the optical element 202 is a telecentering lens and includes at least two cylindrical optical surfaces. Additionally or alternatively, the optical element 202 has a concave surface/side oriented towards the PGU 101. Additionally or alternatively, the optical element 202 is formed into a rectangular polyhedral shape. Additionally or alternatively, the optical element 203 is a prism or has a prismatic shape and includes at least two refractive optical surfaces and at least one reflective optical surface. In one example, the at least two refractive optical surfaces are each freeform refracting optical surfaces and the at least one reflective optical surface is a planar reflecting optical surface. Individual freeform refracting optical surfaces may have the same surface shape/geometry as the other freeform refracting optical surfaces, or may have different surface designs/geometries than the other freeform refracting optical surfaces. Additionally or alternatively, the at least one planar reflecting optical surface is disposed between the at least two freeform refracting optical surfaces. Additionally or alternatively, the at least one reflective optical surface of the optical element 203 is within the optical element 203 and is oriented at an angle with respect to the optical element 202 and/or the combiner 103. Additional aspects of the corrector 102 and other elements of the HUD 100 are discussed in Int'l App. No. PCT/IB2021/056977 filed on Jul. 20, 2021, the contents of which is hereby incorporated by reference in its entirety.

During operation, the HUD 100 is capable of forming full-colored images as follows. The PGU 101 projects laser light (or otherwise generates light) through various optical elements of the corrector 102. In particular, the PGU 101 creates and projects an intermediate image onto the diffusing element 105. After scattering at the diffusing element 105, the rays propagate through the corrector 102 and reach the combiner 103. At least one of the optical surfaces of the corrector 102 does not have rotational symmetry (e.g., surface 120), which provides the optical path length that monotonically increases from the center of the FoV in the direction of the horizontal FoV for the rays propagating from the PGU 101 to the combiner 103. The combiner 103 redirects the rays into the eye box 104. The observer 104 perceives the stereoscopic depth of field and sees virtual objects at different distances from the eye box 104 those complements the surrounding world (e.g., the real images/objects in the FoV). Moreover, the perception of the virtual objects in the FoV of the HUD corresponds to the natural perspective.

In addition to the various implementations discussed previously, additional implementations of the HUD 100 are possible. Additionally or alternatively, some or all of the components of the HUD 100 can be included in a single housing or frame. For example, the PGU 101 (or multiple PGUs 101) may be disposed in the same housing/frame as the corrector 102. Any of the aforementioned implementations may be combined or rearranged depending on the specific use cases involved and/or the environment in which the HUD 100 is deployed/disposed.

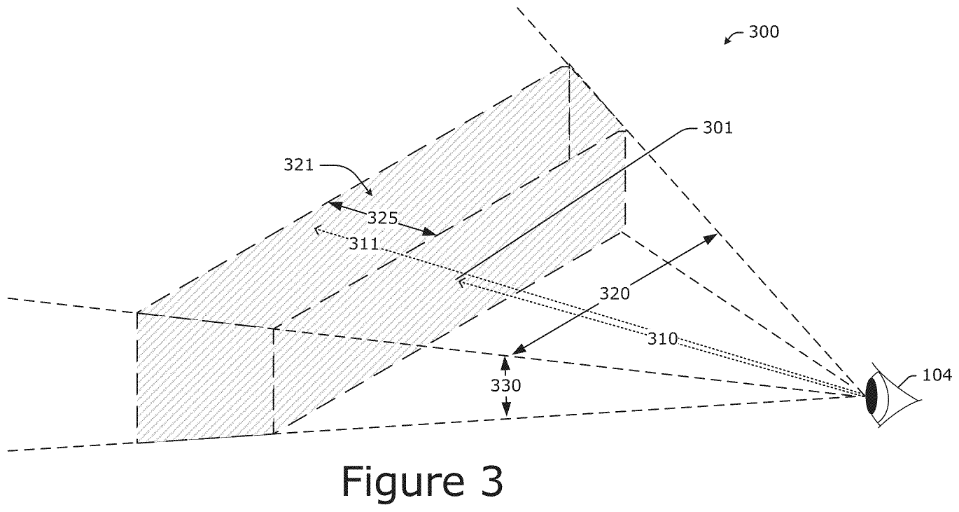

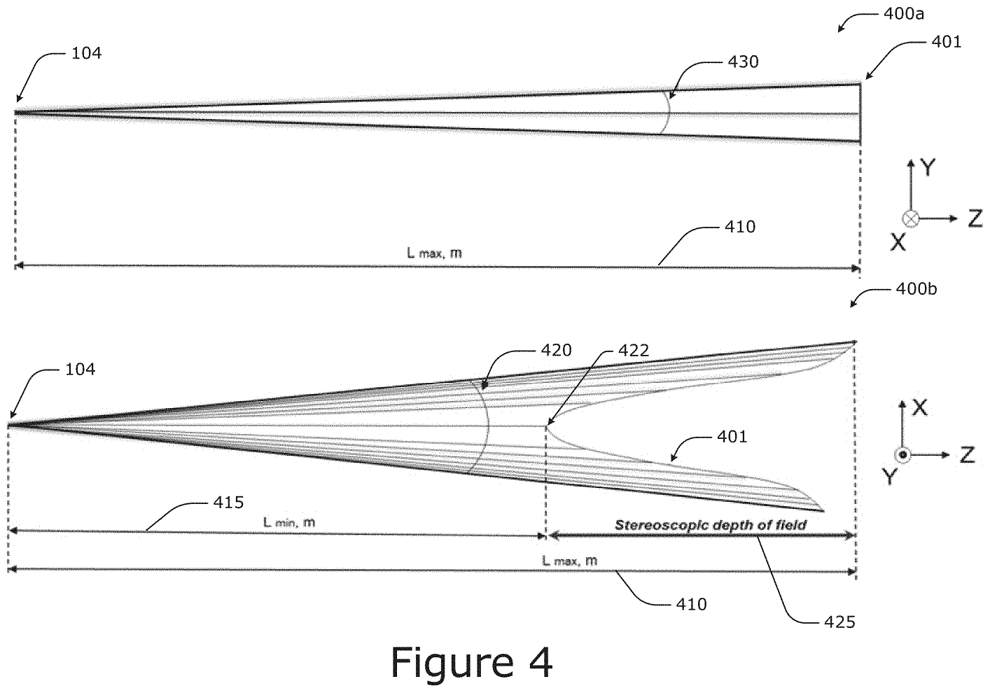

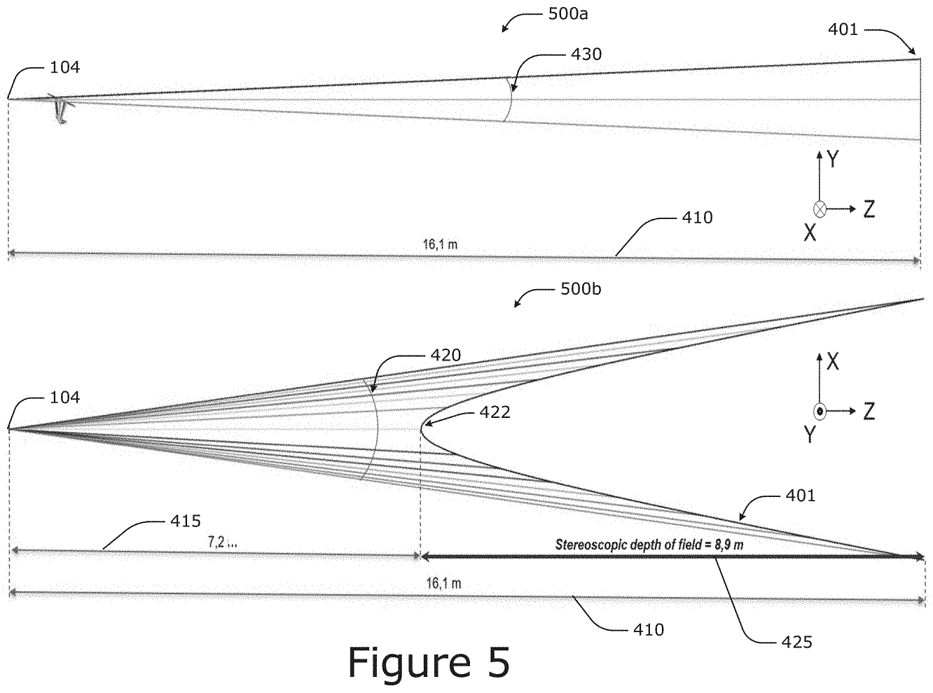

FIG. 3 depicts an example FoV and SDoF model 300 of a HUD showing an eye box 104 in relation to a virtual image 301. A distance between the eye box 104 and the nearest segment of the 3D virtual image 301 is the minimum virtual image distance (VID) 310. A distance between the eye box 104 and the farthest segment of the 3D virtual image 321 is referred to as the maximum VID 311. The FoV includes a horizontal FoV (HFoV) 320 and vertical FoV (VFoV) 330 specified in degrees (°), which define the display size or display area. In some implementations, the FoV of the HUD can be defined in terms of the area in which the observer/eye box 104 is able to view the entire display area, or can be expressed as the entire display area that is observable by the observer/eye box 104. The model 300 of a HUD has a stereoscopic depth of field 325 (i.e., SDoF 325), which is a distance range or length within which virtual objects can be displayed at different distances, complement the real world surrounding, as viewed by the observer/eye box 104.

FIG. 4 shows the shape of a virtual image surface (VIS) 401 according to various embodiments. In particular, a virtual image distance (VID) 410 from the eye box 104 to the surface of the VIS 401 is shown in a vertical section 400a and a horizontal section 400b. Here, the VIS 401 is curved, and in some implementations, the VIS 401 may have a cylindrical shape or some other suitable shape. The vertical section 400a includes a VFoV 430 and the horizontal section 400b includes a HFoV 420. The ray path includes a maximum (max) VID 410 having a maximum length Lₘₐₓ (expressed in meters (m)). The max VID 410 comprises a minimum (min) VID 415 having a minimum length Lₘᵢₙ (expressed in meters (m)) and a SDoF 425. The min VID 415 is a distance from the eye box 104 to an apex 422 of the cylindrical VIS 401, and the SDoF 425 in linear measure is a distance from the apex 422 to an end (or maximum extent) of the VIS 401.

FIG. 5 shows the shape of the VIS 401 of FIG. 4 for a particular use case, where vertical section 500a corresponds to vertical section 400a of FIG. 4 and horizontal section 500b corresponds to the horizontal section 400b of FIG. 4. In the example of FIG. 4, the max VID 410 is 16.1 m (e.g., Lₘₐₓ=16.1 m), the min VID 415 is 7.2 m (e.g., Lₘᵢₙ=7.2 m), and the SDoF 425 in linear measure is 8.9 m (e.g., SDoF=8.9 m).

Additionally or alternatively, an example implementation of the HUD 100 may include the parameters shown by Table 0.

TABLE 0
example optical system parameters

| Element | Parameter |
|---|---|
| FoV | 14° × 4° |
| Distance from the center of the combiner 103 to the | 900 millimeters |
| eye box 104 | (mm) |
| Size of eye box 104 | 130 mm × 60 mm |
| VID 310/410 rage | 7.2 m-16.1 m |
| SDoF 425 | 4.9 mrad |
| Maximum angular size of a symbol for the SDoF 425 | 5.7° |
| (or stereothreshold) of 150″ (in the center of the | |
| FoV) | |
| Maximum angular size of a symbol for the SDoF 425 | 0.5° |
| (or stereothreshold) of 150″ (at the side area of the | |
| FoV) | |

Additional values of various parameters of an example implementation of the HUD 100 are listed in Table 1.

TABLE 1
example optical system parameters

| Element | # | Shape | Radius | Thickness | Material | Conic | Dec X | Dec Y | Tilt X | Tilt Y | Tilt Z |
|---|---|---|---|---|---|---|---|---|---|---|---|
| | 0 | Biconic | Infinity | −7257 | — | 0 | 0 | 0 | 0 | 0 | 0 |
| Virtual | | | −110.5 | | | −1.025 | | | | | |
| Image | | | | | | | | | | | |
| Entrance | 1 | Flat | Infinity | 900 | — | 0 | 0 | 0 | 0 | 0 | 0 |
| Pupil | | | | | | | | | | | |
| Dummy | 2 | — | — | 0 | — | — | 0 | 0 | 70 | 0 | 0 |
| Surface | | | | | | | | | | | |
| Dummy | 3 | — | — | 0 | — | — | 0 | 0 | 0 | 2.7 | 0 |
| Surface | | | | | | | | | | | |
| Combiner | 4 | Zernike | −9800 | 0 | Mirror | 0 | 0 | 0 | 0 | 0 | 0 |
| | | Fringe | | | | | | | | | |
| | | Phase | | | | | | | | | |
| Dummy | 5 | — | — | −238 | — | — | 0 | 0 | −16 | 0 | 0 |
| Surface | | | | | | | | | | | |
| Dummy | 6 | — | — | 0 | — | — | 0 | 0 | 25.7 | 0 | 0 |
| Surface | | | | | | | | | | | |
| Prism First | 7 | Polynomial | −704.2 | −47 | H-K9L | 0 | 0 | 0 | 0 | 0 | 0 |
| Surface | | | | | | | | | | | |
| Dummy | 8 | — | — | 0 | — | — | 0 | 0 | 25 | 0 | 0 |
| Surface | | | | | | | | | | | |
| Prism | 9 | Flat | Infinity | 0 | Mirror | 0 | 0 | 0 | 0 | 0 | 0 |
| Second | | | | | | | | | | | |
| Surface | | | | | | | | | | | |
| Dummy | 10 | — | — | 73 | — | — | 0 | 0 | 25 | 0 | 0 |
| Surface | | | | | | | | | | | |
| Dummy | 11 | — | — | 0 | — | — | 0 | −35.7 | 17.5 | 0 | 0 |
| Surface | | | | | | | | | | | |
| Prism Third | 12 | Polynomial | −300.5 | 0 | — | 0 | 0 | 0 | 0 | 0 | 0 |
| Surface | | | | | | | | | | | |
| Dummy | 13 | — | — | 23.6 | — | — | 0 | 35.7 | −17.5 | 0 | 0 |
| Surface | | | | | | | | | | | |
| Dummy | 14 | — | — | 0 | — | — | 0 | 42.6 | 15 | 0 | 0 |
| Surface | | | | | | | | | | | |
| Lens First | 15 | Spherical | −233.8 | 8.5 | H-K9L | 0 | 0 | 0 | 0 | 0 | 0 |
| Surface | | | | | | | | | | | |
| Lens | 16 | Biconic | 22.8 | 0 | — | 0 | 0 | 0 | 0 | 0 | 0 |
| Second | | | Infinity | | | 0 | | | | | |
| Surface | | | | | | | | | | | |
| Dummy | 17 | — | — | 3 | — | — | 0 | −0.1 | −0.4 | 0 | 0 |
| Surface | | | | | | | | | | | |
| Diffuser | 18 | Flat | Infinity | 2 | H-K9L | 0 | 0 | 0 | 0 | 0 | 0 |
| First | | | | | | | | | | | |
| Surface | | | | | | | | | | | |
| Diffuser | 19 | Flat | Infinity | — | — | 0 | 0 | 0 | 0 | 0 | 0 |
| Second | | | | | | | | | | | |
| Surface | | | | | | | | | | | |

In Table 1, “H-K9L” refers to borosilicate glass (sometimes referred to as boron crown glass) used for optical elements, which may have a refractive index of about 1.509 to 1.517 and a dispersion (Abbe number) of about 64.17 to 64.20. H-K9L is equivalent to Schott® BK78 and Schott® N-BK7®, and additional properties of such materials are discussed in “Schott® Optical Glass Collection Datasheets”, available at: https://www.schott.com/en-gb/products/optical-glass-p1000267/downloads. Schott AG (2014) (“[Schott]”), the contents of which is hereby incorporated by reference in its entirety. Additional or alternative materials may be used such as fused silica, calcium fluoride (CaF₂), zinc selenide (SeZn or ZnSe), germanium, and/or any other optical material having a relatively high transmittance such as those discussed in [Schott].

In various embodiments, the optical system (e.g., HUD 100) comprises spherical, cylindrical, and/or freeform surfaces. In some implementations, the lens 202 of the corrector 102 comprises two cylindrical surfaces expressed by equation (1).

$$z = \frac{\frac{1}{{R}_{x}} {x}^{2} + \frac{1}{{R}_{y}} {y}^{2}}{1 + \sqrt{1 - ( 1 + {k}_{x} ) \frac{1}{{R}_{x}} {x}^{2} - ( 1 + {k}_{y} ) \frac{1}{{R}_{y}} {y}^{2}}} \qquad ( 1 )$$

In equation (1), z is the sag of the lens 202, and Rₓ, R_{y} and kₓ, k_{y}. are the radii and conic constants in the two orthogonal sections, respectively. In particular, Rₓ is a radius of curvature (RoC) in the horizontal section 400b, R_{y} is a RoC in the vertical section 400a, kₓ is a conic constant for the horizontal section 400b, and k_{y} is a conic constant for the vertical section 400a. In some implementations, the refraction surfaces of the prism 203 are freeform surfaces, which can be expressed by equation (2).

$$z = \frac{{x}^{2} + {y}^{2}}{R [ 1 + \sqrt{1 - ( 1 + k ) {( \frac{\sqrt{{x}^{2} + {y}^{2}}}{R} )}^{2} ]}} + {\sum }_{i = 1}^{N} {A}_{i} {E}_{i} \qquad ( 2 )$$

In equation (2), z is the sag of the prism 203, R is the second-order RoC, k is the second-order conic constant, and Aᵢ is the coefficient on the polynomial term Eᵢ. Holographic combiner 103 represents a phase grating formed on a spherical substrate for the wavelength of 532 nanometers (nm), where the phase of the surface is given by equation (3).

Φ=MΣᵢ₌₁^{N}2πAᵢZᵢ(ρ,φ) (3)

In equation (3), Φ is the phase of the surface, M is a diffraction order equal to 1, and Aᵢ is a coefficient on the Zernike Fringe polynomial Zᵢ. Coefficients Aᵢ on the polynomial terms Eᵢ for the surfaces 7 and 12 listed in Table 2, coefficients Aᵢ on the polynomial terms Zᵢ for the holographic combiner 103 are listed in Table 3.

TABLE 2
Coefficients on the polynomial terms for the surfaces 7 and 12

| # | Comment | Surface 7 | Surface 12 |
|---|---|---|---|
| 1 | X1Y0 | 0 | 0 |
| 2 | X0Y1 | 0 | 0 |
| 3 | X2Y0 | 2.67E−03 | 1.16E−03 |
| 4 | X1Y1 | −1.27E−04 | 6.87E−04 |
| 5 | X0Y2 | 2.90E−04 | 6.79E−03 |
| 6 | X3Y0 | 7.57E−07 | 5.78E−07 |
| 7 | X2Y1 | −2,26E−05 | 7.98E−06 |
| 8 | X1Y2 | 1.67E−06 | −1.80E−05 |
| 9 | X0Y3 | −1.02E−05 | −4.05E−05 |
| 10 | X4Y0 | −1.82E−07 | 1.74E−08 |
| 11 | X3Y1 | −4.71E−09 | 6.19E−08 |
| 12 | X2Y2 | −3.05E−07 | 2.55E−06 |
| 13 | X1Y3 | −2.64E−09 | 2.11E−07 |
| 14 | X0Y4 | −5.06E−08 | 6.99E−07 |
| 15 | X5Y0 | −6.81E−11 | −8.64E−10 |
| 16 | X4Y1 | 2.40E−09 | 9.97E−10 |
| 17 | X3Y2 | −2.17E−10 | 6.61E−09 |
| 18 | X2Y3 | 2.86E−09 | 4.65E−08 |
| 19 | X1Y4 | −5.90E−11 | 2.14E−08 |
| 20 | X0Y5 | 1.78E−10 | 1.42E−07 |
| 21 | X6Y0 | 5.36E−12 | 5.75E−11 |
| 22 | X5Y1 | 1.18E−12 | 3.60E−11 |
| 23 | X4Y2 | 1.19E−11 | −1.66E−10 |
| 24 | X3Y3 | 1.72E−12 | −1.84E−10 |
| 25 | X2Y4 | 8.28E−14 | −1.73E−09 |
| 26 | X1Y5 | −6.84E−13 | −2.28E−10 |
| 27 | X0Y6 | −1.71E−12 | −1.91E−09 |
| 28 | X7Y0 | 3.66E−15 | 1.27E−13 |
| 29 | X6Y1 | −1.31E−13 | −2.16E−12 |
| 30 | X5Y2 | 1.66E−14 | −2.25E−12 |
| 31 | X4Y3 | −2.66E−13 | −2.04E−11 |
| 32 | X3Y4 | 1.32E−14 | −1.32E−11 |
| 33 | X2Y5 | −7.63E−14 | −5.52E−11 |
| 34 | X1Y6 | 8.60E−16 | −8.22E−12 |
| 35 | X0Y7 | 9.96E−15 | −9.52E−11 |
| 36 | X8Y0 | −1.59E−17 | −9.40E−15 |
| 37 | X7Y1 | −3.97E−17 | −7.88E−15 |
| 38 | X6Y2 | −4.36E−16 | 4.85E−14 |
| 39 | X5Y3 | −1.78E−16 | 1.28E−13 |
| 40 | X4Y4 | −2.49E−16 | 5.83E−13 |
| 41 | X3Y5 | −3.00E−17 | 1.03E−13 |
| 42 | X2Y6 | −7.90E−17 | 6.24E−13 |
| 43 | X1Y7 | 4.06E−17 | 1.24E−13 |
| 44 | X0Y8 | 1.11E−16 | 1.37E−13 |
| 45 | X9Y0 | −1.69E−19 | 0 |
| 46 | X8Y1 | 3.84E−18 | 0 |
| 47 | X7Y2 | −8.71E−19 | 0 |
| 48 | X6Y3 | 8.32E−18 | 0 |
| 49 | X5Y4 | −8.88E−19 | 0 |
| 50 | X4Y5 | 5.47E−18 | 0 |

TABLE 3
Coefficients on the Zernike Fringe polynomial

| # | Aᵢ |
|---|---|
| 1 | 0 |
| 2 | 11636.11 |
| 3 | 488040.4 |
| 4 | −130458 |
| 5 | −9488.12 |
| 6 | −239.93 |
| 7 | 754.3213 |
| 8 | 14865.99 |
| 9 | 7790.989 |
| 10 | 1000.207 |
| 11 | −1606.43 |
| 12 | −822.136 |
| 13 | −368.877 |
| 14 | 198.0682 |
| 15 | −2392.21 |
| 16 | −1324.38 |
| 17 | −4833.99 |
| 18 | −263.545 |
| 19 | 350.6887 |
| 20 | −845.304 |
| 21 | −1143.01 |
| 22 | −183.549 |
| 23 | −120.109 |
| 24 | 751.9224 |
| 25 | −57.5084 |
| 26 | 3.590285 |
| 27 | −467.808 |
| 28 | −240.02 |
| 29 | −50.9478 |
| 30 | 42.26304 |
| 31 | −54.0651 |
| 32 | −373.484 |
| 33 | −48.6699 |
| 34 | −35.0206 |
| 35 | 226.6184 |
| 36 | 87.45875 |
| 37 | 22.05233 |

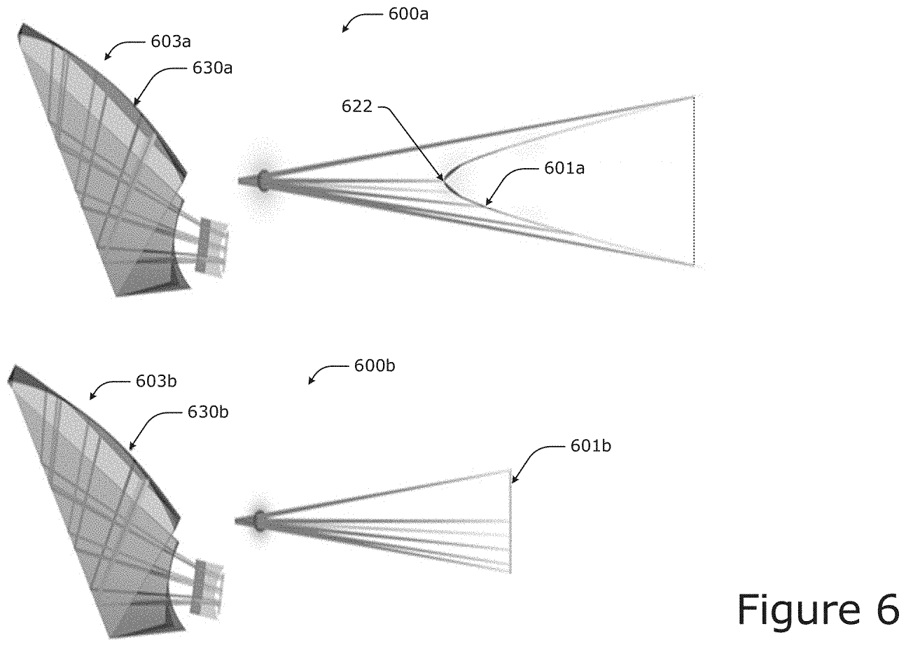

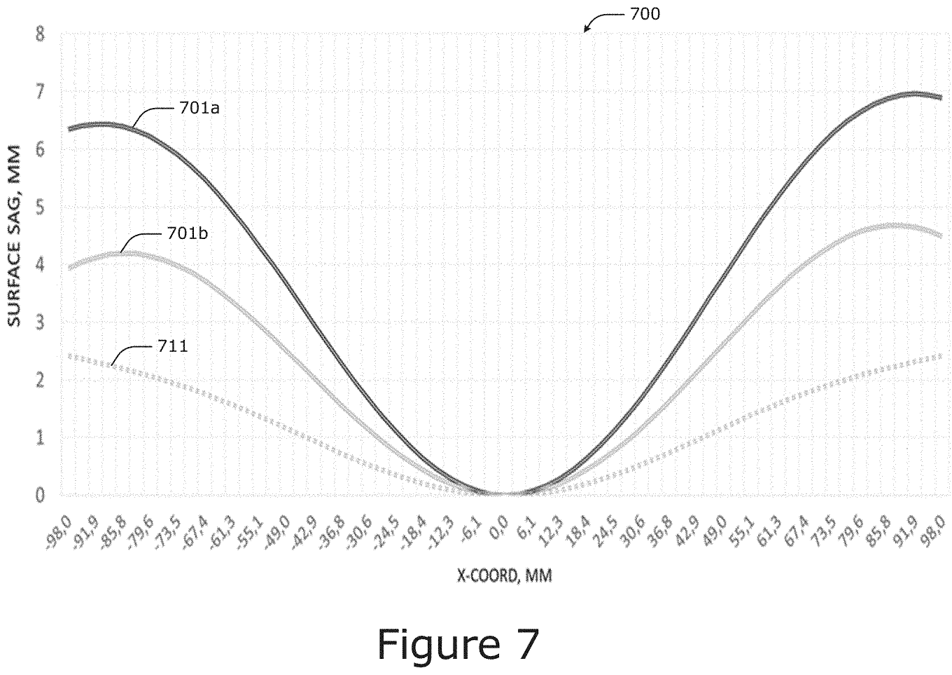

FIG. 6 shows a comparison of VISs of two optical systems including AR HUD 600a and AR HUD 600b. AR HUDs 600a and 600b comprise prisms 603a and 603b, respectively, and are capable of generating the VIS. Specifically, AR HUD 600b is configured to generate a planar VIS 601b without SDoF, whereas AR HUD 600a is configured to generate a curved VIS 601a having a SDoF (e.g., SDoF 425).

To create the curved VIS 601a, the AR HUD 600a includes at least one rotationally asymmetric and/or freeform optical surface 630a, which enables the optical path length of light rays (propagating from the PGU to the combiner) to monotonically increase from the center of the FoV (e.g., apex 622) in the direction of the HFoV 420, and therefore, to provide the SDoF 425. However, AR HUDs with a planar VIS without SDoF (e.g., AR HUD 600b) can also comprise rotationally asymmetric optical surfaces as well. Therefore, to create the SDoF 425, the differences in surface sags (or Sagitta) in two nearly identical correctors 102 of the optical systems 600a and 600b is based on the shape, curve, and/or other properties of the optical surfaces 630a and 630b of prisms 603a and 603b. Specifically in this example, the two AR HUDs 600a and 600b differ only in the shape of the respective optical surfaces 630a and 630b of their respective prisms 603a and 603b. In other words, the optical surface 630a of prism 603a has a different shape, curve, and/or other properties than the shape, curve, and/or other properties of optical surface 630b of prism 603b.

FIG. 7 includes a graph 700 showing a comparison of the prism surface sags in AR HUD 600a and AR HUD 600b. The x-axis of graph 700 includes optical surface x-coordinate values (expressed in millimeters), and the y-axis of graph 700 includes surface sag values (expressed in millimeters). In graph 700, curve 701a corresponds to the sag of the optical surface 630a of prism 603a, curve 701b corresponds to the sag of the optical surface 630b of prism 603b, and curve 711 is the difference between the sags 701a and 701b. The difference curve 711 is monotonically increasing from the center of the FoV along the direction of the HFoV. Considering the fact that all other optical surfaces in AR HUD 600a and AR HUD 600b (except surfaces 603a and 603b) are equal, the monotonic increase of the difference curve 711 explains the monotonic increase in the optical ray path length in AR HUD 600a for the rays propagating from the PGU 101 to the combiner 103 via the corrector 102. The monotonic increase in the optical ray path length provides the SDoF 425 and positive visual ergonomic effects.

FIG. 8 shows an example driving scenario where a vehicle 820a, 820b is making a turning maneuver with virtual navigation arrows guiding the vehicle's 820a, 820b route. The vehicle 820b includes an AR HUD that generates a VIS shape 800b where a virtual navigation arrow does not correspond to the real world driving direction 803. The VIS shape 800b has a VIS 801b along which virtual objects will be placed. The VIS shape 800b also includes a virtual interface 811b showing a direction and/or orientation of the virtual objects when displayed with real world objects. Here, a convex side 802b of the VIS shape 800b is oriented away from an observer within the vehicle 820b. This means that virtual images will be placed along the VIS 801b and virtual interface 811b that points towards an apex of the convex side 802b. In this example, when the vehicle 820b approaches an intersection to make a right turn maneuver, a virtual driving arrow on the right side of the observer's FoV is directed forward-left, not forward-right, which can lead to disorientation and unsafe driving scenarios.

FIG. 8 also shows an example VIS shape 800a generated by an AR HUD (e.g., AR HUD 600a of FIG. 6) in a vehicle 820a, where the virtual driving direction corresponds to the real driving direction 803. The VIS shape 800a has a VIS 801a along which virtual objects will be placed, and a virtual interface 811a showing an direction and/or orientation of the virtual objects when displayed with real world objects. Here, a convex side 802a of the VIS shape 800a is oriented towards an observer within the vehicle 820a. This means that virtual images will be placed along the VIS 801a and virtual interface 811a that points away from an apex of the convex side 802a. In this example, when the vehicle 820a approaches an intersection to make a right turn maneuver, a virtual driving arrow on the right side of the observer's FoV will be directed forward-right in alignment with the real trajectory 803. Unlike the VIS shape 800b, the VIS shape 800a has its convex side 802a oriented toward the observer, and thus, the virtual objects (e.g., TBT pointers/arrows) corresponds to the real world objects (e.g., real driving direction 803). The aforementioned implementations, and the various embodiments discussed infra, provide an advantage over conventional HUDs in that the shape of the VIS 801a (including an SDoF) allows the virtual driving direction to be displayed according to natural perception of the real driving direction. For example, when the AR HUD 100 displays TBT pointers for travel route, the shape of the VIS 801a (including an SDoF) allows the TBT pointers to be displayed on or at the real-world driving direction (trajectory) 803. In the conventional HUDs discussed previously, a VIS is provided with a convex side that is oriented away from the observer, which is the opposite orientation of the VIS generated according to the embodiments herein.

FIG. 9 shows an example driving scenario where a vehicle 920a, 920b is following (or approaches) another vehicle 922a, 922b. The vehicle 920a includes an AR HUD (e.g., AR HUD 600a of FIG. 6) that generates a VIS shape 900a, which may be the same or similar to VIS shape 800a of FIG. 8. Here, the VIS shape 900a “wraps” around the vehicle 922a in front of the vehicle 920a. By contrast, vehicle 920b includes an AR HUD that generates a VIS shape 900b, which may be the same or similar to the VIS shape 800b of FIG. 8. Here, the VIS shape 900b envelopes or overlaps the vehicle 922b in front of the vehicle 920b. In this case, virtual images placed along the VIS shape 900b will appear further away from the vehicle 920b than the front vehicle 922b. Situations in which virtual objects overlap with real world objects (e.g., front vehicle 922b), or are displayed beyond real world objects (e.g., beyond front vehicle 922b) can be quite unpleasant in terms of comfort of the visual perception and driving safety. In other words, distances at which the virtual objects are displayed does not correctly correspond to the distances of the real objects to which they should be complemented. This situation may arise often in crowded areas such as highway or urban environments, where speed is usually low and/or vehicles are relatively close to one another.

FIG. 10 depicts an example partitioning scheme 1000 for partitioning an HFoV into segments 1010 according to various embodiments. As alluded to previously, the optical systems (e.g., HUD 100) increase in the visual perception quality by imaging virtual objects in the display FoV according to a natural perspective. The corrector 102 is implemented in such a way that it enables an optical path length to monotonically increase from the center of the FoV in the direction of the HFoV for the rays 1015 propagating from the PGU 101 to the combiner 103. Thus, the VIS 401 has a U-shape and/or a cylindrical shape with a convex side 1022 oriented towards the observer 104. Additionally, the side areas of the VIS 401 gradually move away from the observer 104. Furthermore, the angle α between an arbitrary chief ray 1015, aimed along the direction of the HFoV, and a normal to the VIS 1001 becomes larger as the chief ray 1015 travels further from the center of the FoV 1022. This means that the usable size of the virtual object, which does not appear to be inclined, will appear smaller the further that the virtual object is from an observer 104, and hence from the center of the FoV, along the direction of the HFoV.

The partitioning scheme 1000 includes a set of local segments 1010 (or simply “segments 1010”). In FIG. 10, only the segments 1010 for half of the HFoV are shown. Each segment 1010 has two endpoints 1005 based on respective rays 1015 between the observer 104 and the VIS 1001. In this implementation, each segment 1010 has a SDoF of about 150 arcseconds (″). Here, if a real stereothreshold for the interface is at or close to 150″, then virtual objects displayed within individual segments 1010 should not appear to be inclined to the observer 104. The angular size of each local segment 1010 are shown by FIG. 10 (in degrees) in accordance with an implementation example, although other angular sizes are possible in other implementations.

The partitioning scheme 1000 also includes angles α at each endpoint 1005 between two segments 1010 (note that only two angles, angle α₁ and angle α₂, are shown in FIG. 10 for the sake of clarity). Each angle α is an angle between a normal 1002 of the VIS 1001 and a ray 1015 propagating between the observer 104 and the VIS 401. Here, angle α₁ is an angle between a normal 1002 of the VIS 1001 and a first chief ray 1015₁, and angle α₂ is an angle between a normal 1002 of the VIS 1001 and a second chief ray 1015₂, where the second chief ray 1015₂ is propagating farther from the center of the FoV than the first chief ray 1015₁, and the first chief ray 1015₁ is propagating closer to the center of the FoV than the second chief ray 1015₂. In this implementation, the angle α2 is greater than the angle α₁, and segments 1010 located closer to the observer 104 have a greater angular size than the segments 1010 located farther away from the observer 104. This feature corresponds to a natural perspective for the observer 104. Displaying virtual objects in accordance with natural perspective increases the quality of visual perception through more efficient use of the FoV and the SDoF since natural perspective corresponds to real human's perception of 3D space.

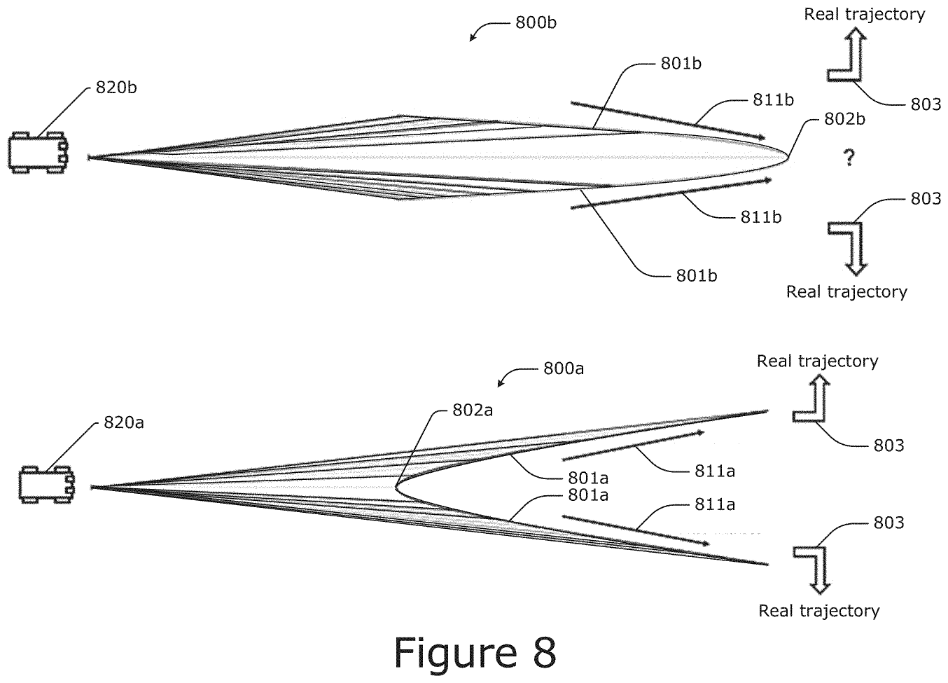

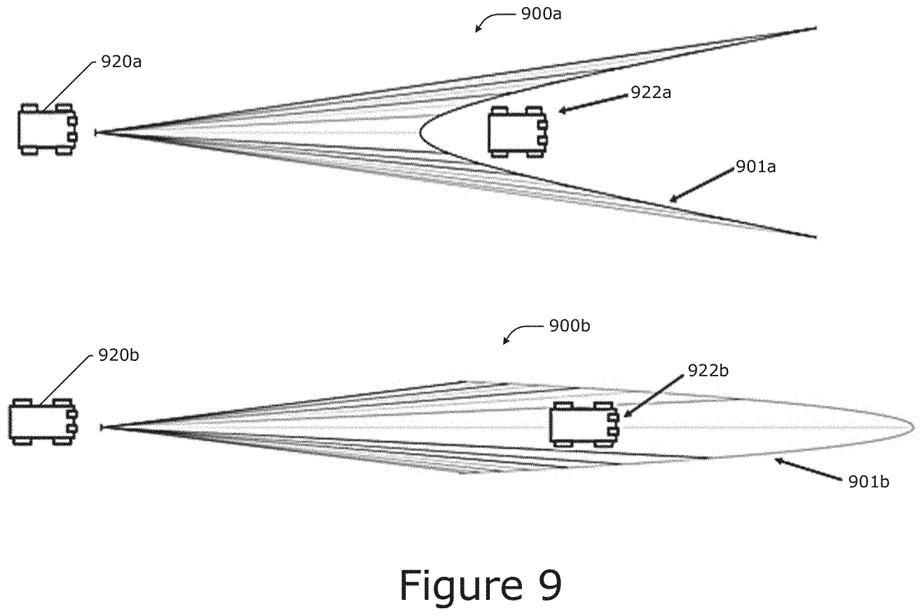

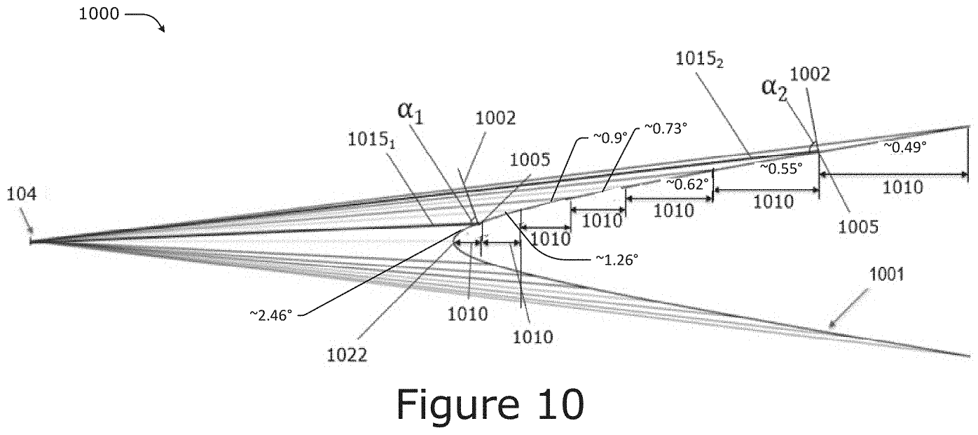

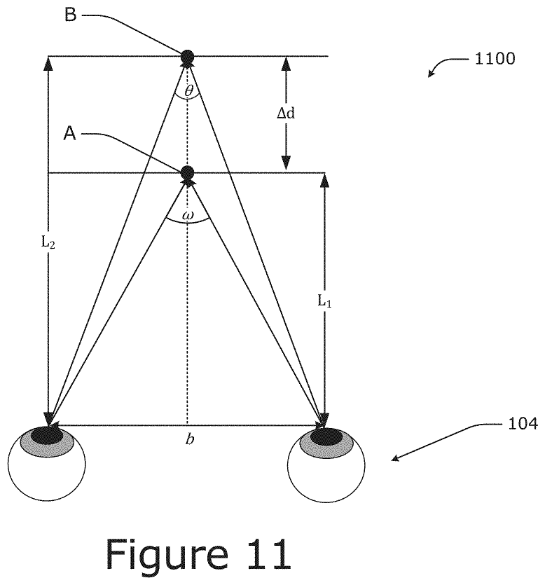

FIG. 11 depicts an SDoF model 1100. As mentioned previously, the AR HUD 100 provides improved visual ergonomics in comparison to existing/conventional AR HUDs due to the greater SDoF provided by the AR HUD 100. The SDoF δ can be expressed as the difference between the angle ω converging on the object A located closer to the eye box 104 and the angle θ of object B located further from the eye box 104. The SDoF δ can be calculated using equation (4).

δ=ω−θ (4)

The difference between these angles depends on the viewing distance L to the object, interocular distance b, and therefore, the SDoF δ can also be expressed using equation (5).

δ≅b/L₁−b/L₂ (5)

In equation (5), viewing distance L₁ is the viewing distance between the eye box 104 and the object A, viewing distance L₂ is the viewing distance between the eye box 104 and the object B, and b is the interocular distance. Furthermore, the difference between the viewing distance L₁ and viewing distance L₂ is the perceived depth Δd in linear measure. In one example implementation, where the viewing distances L₁ and L₂ varies in the range of 7.2 m to 16.1 m (e.g., Δd=8.9 m) and the interocular distance b, the SDoF δ is equal to 4.9 milliradians (mrad). In the AR HUD 100, the greater the SDoF δ is reached through the wider FoV, while the size of the virtual object, which does not exceed the stereothreshold (e.g., the virtual object does not appear to be inclined), remains unaffected.

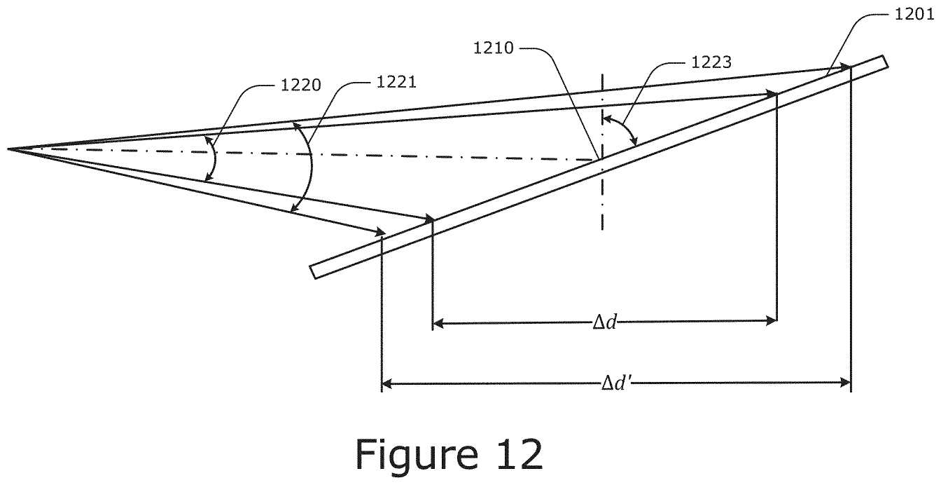

FIG. 12 shows the dependence of the SDoF on the size of an FoV. Here, the SDoF becomes greater as the FoV becomes wider. In FIG. 12, the VIS 1201 has a one-dimensional tilt around a central point of the FoV. For example, assuming that the tilt angle 1223 of 79° (e.g., α=79°) and the central point 1210 of the FoV is 10 m away from the observer 104, then the SDoF δ will be 2.3 mrad for an FoV 1220 of 4° and the SDoF δ will be 4.1 mrad for an FoV 1221 of 7°. Converted to the range of distances, for FoV 1220, there is a perceived depth of 3.7 m (e.g., Δd=3.7 m), and for FoV 1221, there is a perceived depth of 7.1 m (e.g., Δd′=3.7 m).

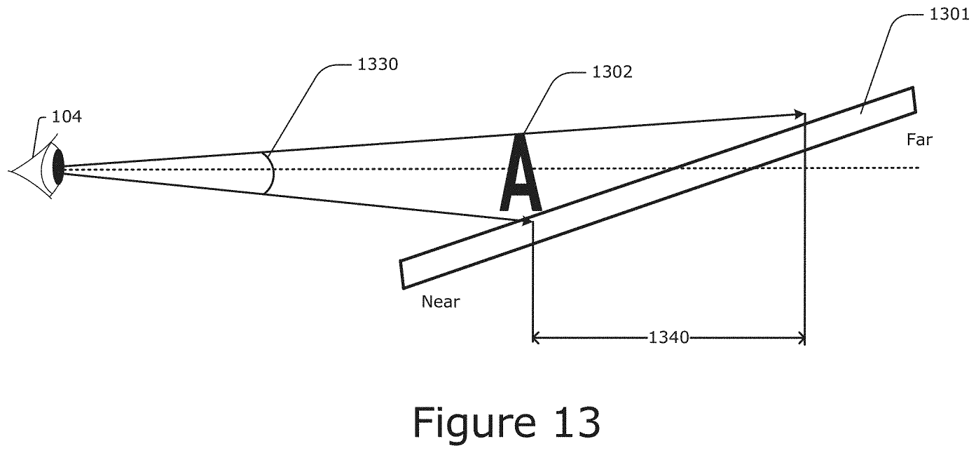

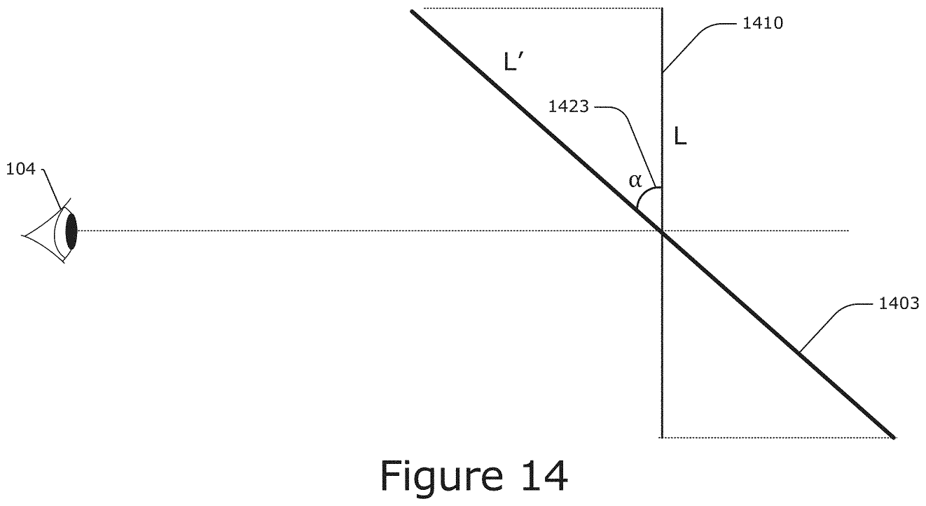

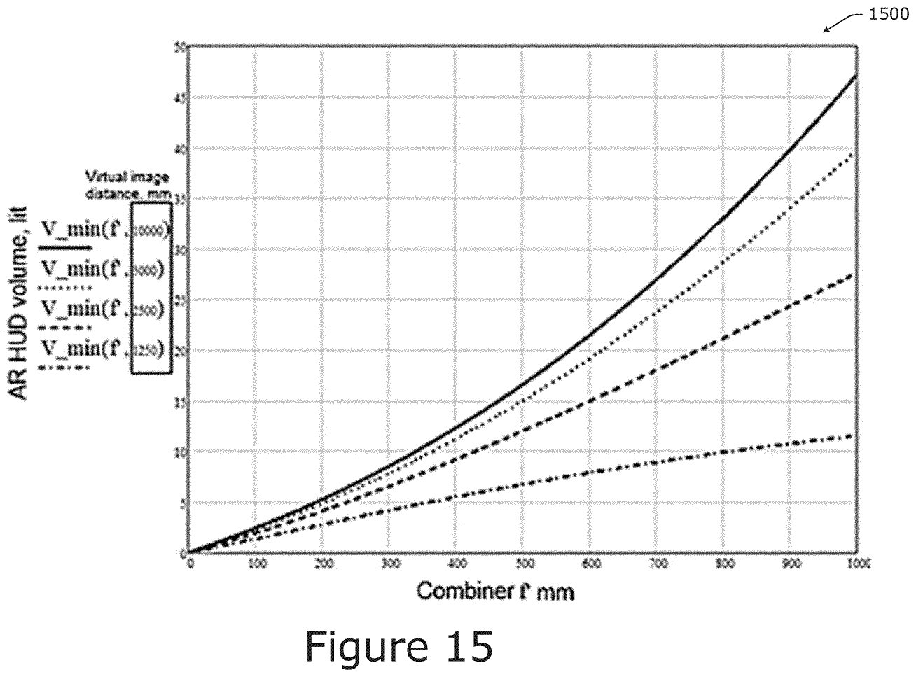

FIG. 13 shows a maximum usable size 1330 of a virtual object 1302, which does not exceed the stereothreshold 1340. Here, the maximum usable size 1330 of the virtual object 1302 that does not exceed the stereothreshold 1340 is a size at which the virtual object does not appear to be inclined to the observer 104. In the example of FIG. 13, the stereothreshold 1340 is 150″.

One reason the AR HUD 100 can have a greater SDoF than the SDoF in existing/conventional AR HUDs is that the SDoF of the AR HUD 100 is achieved in the direction of the HFoV, while in the existing/conventional AR HUDs the SDoF is achieved in the direction of the VFoV. FIG. 14 shows the difficulty of increasing the size of the VFoV for a typical AR HUD geometry. As shown by FIG. 14, the difficulty of increasing the size of the VFoV, compared to increasing the HFoV, is based on the relation of the length L of the projection of the combiner 1403 onto the vertical plane 1410 to the actual size L′ of the combiner 1403.

The typical combiner 1403 inclination angle 1423 is not less than 60 degrees (e.g., α≥60), and the vertical size L′ of the combiner 1403 will be at least two times bigger than its projection onto the vertical plane 1410. However, there is no such a problem for the horizontal plane. Therefore, all things being equal, the maximum achievable typical VFoV will be at least two times smaller than the HFoV because of the limitations on the combiner size L′, large numerical aperture, and aberrations, rapidly increasing in the direction of the VFoV (especially astigmatism). It also can be illustrated by typical values of the FoVs of the existing HUDs, including those discussed previously including 5.4×1.8; 10×4; 12×3 degrees.

Another reason the AR HUD 100 can have a greater SDoF than existing/conventional AR HUDs is that the combiner 103 is implemented as a holographic optical element (HOE) with positive optical power to additional increase both the HFoV and the VFoV in comparison with the existing HUDs (see e.g., FIG. 12, which shows the dependence between the SDoF and the FoV size). In one example implementation, the optical power of the combiner 103 is 2.85 diopters and the combiner focal length is 350 mm. While in existing/conventional AR HUDs, one of the factors that limit the expansion of the FoV is the limitation on the combiner size, which is related to the low optical power of the combiner (˜<1 diopter). The lower the optical power of the combiner, the smaller the FoV that might be reached, remaining the limitations on the optical system size.

FIG. 15 depicts a graph 1500 showing the dependence of the volume of a typical AR HUD from the optical power of the combiner for different distances to a virtual image.

The data given in graph 1500 is provided for different distances to the virtual image, given in millimeters (mm). For FIG. 15, the typical AR HUD was given the following system parameter values: the eye box to combiner distance is 700 mm, the radius of the circular eye box is 71 mm, the FoV radius is 6.5°.

The graph 1500 shows that the increase in the volume of the typical AR HUD is quite fast, considering the sufficient distances to the virtual image (>3 m). The optical power or the focal length of the combiner, which is implemented as an area of the windshield, can be estimated considering the minimum closest radius of curvature at this area. Thus, the typical focal length of a classical combiner is usually greater than 1000 mm, while the holographic combiner 103 of the AR HUD 100 has significantly higher optical power (e.g., a shorter focal length). A high optical power allows the holographic AR HUD 100 to have a wider FoV, and therefore, a greater SDoF thereby providing improved visual ergonomics.

In addition to the various embodiments of the HUD 100 described previously, the HUD 100 may include additional or alternative elements than shown. For example, the HUD 100 may include one or more additional optical elements/components that manipulate light such as lenses, filters, prisms, mirrors, beam splitters, diffusers, diffraction gratings, multivariate optical elements (MOEs), and/or the like. Furthermore, each of the elements/components shown and described herein may be manufactured or formed using any suitable fabrication means, such as those discussed herein. Additionally, each of the elements/components shown and described herein may be coupled to other elements/components and/or coupled to a portion/section of the vehicle by way of any suitable fastening means, such as those discussed herein. Furthermore, the geometry (shape, volume, etc.), position, orientation, and/or other parameter(s) of the elements/components shown and described herein may be different from the depicted shapes, positions, orientations, and/or other parameter(s) in the example embodiments of FIGS. 1-15 depending on the shape, size, and/or other parameters/features of the vehicle in which the AR HUD 100 is disposed, and/or based on the shape, size, position, orientation, and/or other parameters/features of other components/elements of the AR HUD 100 and/or the vehicle in which the AR HUD 100 is disposed.

### 2. Example Implementations

Some non-limiting example as provided infra. The following examples pertain to further embodiments. Specifics in the examples may be used anywhere in one or more embodiments. All optional features of the apparatus(es) described herein may also be implemented with respect to a method or process.

Example A01 includes an optical system comprising a picture generation unit (PGU), a combiner, and a corrector disposed between the PGU and the combiner, wherein the corrector comprises at least one rotationally asymmetric optical surface arranged to provide a stereoscopic depth of field (SDoF) by a monotonically increasing optical path length from a center of a field of view (FoV) in a direction of a horizontal FoV (HFoV) for light rays propagating from the PGU to the combiner via the corrector.

Example A02 includes the optical system of example A01 and/or some other example(s) herein, wherein the at least one rotationally asymmetric optical surface is configured to form a curved virtual image surface (VIS) based on light projected by the PGU.

Example A03 includes the optical system of example A01 or A02 and/or some other example(s) herein, wherein the optical system is configured to form a curved virtual image surface (VIS) as a result of interaction between the PGU, the corrector, and the combiner, and to improve visual ergonomics of the optical system (e.g., driving comfort and safety) by means of aligning one or more real objects with one or more displayed virtual images.

Example A04 includes the optical system of example A03 and/or some other example(s) herein, wherein the one or more real objects include a real driving direction and the one or more displayed virtual images includes a displayed virtual driving direction, and the displayed virtual driving direction is one or more of turn-by-turn (TBT) pointers, turn arrows, or other like graphical elements of a TBT navigation service.

Example A05 includes the optical system of examples A03-A04 and/or some other example(s) herein, wherein the VIS has a cylindrical shape with a convex side of the cylindrical shape oriented towards an observer.

Example A06 includes the optical system of example A05 and/or some other example(s) herein, wherein a directrix of the VIS is a continuous curved lines located along a direction of the HFoV.

Example A07 includes the optical system of examples A01-A06 and/or some other example(s) herein, wherein the corrector is implemented as a combination of optical surfaces including one or more refracting surfaces, one or more reflecting surfaces, or a combination of at least one refracting surface and at least one reflecting surfaces.

Example A08 includes the optical system of examples A01-A07 and/or some other example(s) herein, wherein the combiner is implemented as a holographic optical element with a positive optical power.

Example A09 includes the optical system of examples A01-A08 and/or some other example(s) herein, wherein the corrector is configured to create the optical path length that monotonically increases from the center of the FoV in the direction of the HFoV for the light rays propagating from the PGU to the combiner to form the VIS such that an angle between a chief ray aimed along the direction of the HFoV and a normal to the VIS becomes larger as the chief ray becomes farther from the center of the FoV.

Example A09 includes the optical system of examples A01-A08 and/or some other example(s) herein, wherein the optical system displays virtual objects at different distances from an observer in accordance with natural perspective.

Example A10 includes the optical system of examples A01-A09 and/or some other example(s) herein, wherein the corrector further comprises at least one prism including at least one reflecting optical surface disposed between at least two refracting optical surfaces.

Example A11 includes the optical system of example A10 and/or some other example(s) herein, wherein the at least two refracting optical surfaces are surfaces of the at least one prism.

Example A12 includes the optical system of examples A01-A11 and/or some other example(s) herein, wherein the combiner comprises a holographic optical element (HOE) with an optical power between 1,1-6,6 diopters.

Example A13 includes the optical system of examples A01-A12 and/or some other example(s) herein, wherein the combiner comprises an HOW with an optical power of 2.85 diopters and a focal length of 350 millimeters (mm).

Example A14 includes the optical system of examples A01-A13 and/or some other example(s) herein, wherein the corrector comprises at least one optical element with at least two refractive surfaces.

Example A15 includes the optical system of examples A01-A14 and/or some other example(s) herein, wherein the PGU is communicatively coupled with an in-vehicle computing system, and the PGU is configured to generate three-dimensional (3D) virtual images based on signals obtained from the in-vehicle computing system.

Example A16 includes the optical system of examples A01-A15 and/or some other example(s) herein, wherein the optical system is, or is included in an Augmented Reality (AR) Head-up Display (HUD) device with improved visual ergonomics.

Example B01 includes an optical system comprising: a combiner; a picture generation unit (PGU) configured to project light rays towards the combiner; and a correction optics assembly disposed between the PGU and the combiner, wherein the correction optics assembly comprises at least one rotationally asymmetric optical surface arranged to provide a stereoscopic depth of field (SDoF) by producing an optical path with a monotonically increasing optical path length in a horizontal field of view (HFoV) from light rays propagating from the PGU to the combiner via the correction optics assembly.

Example B02 includes the optical system of example B01 and/or some other example(s) herein, wherein the SDoF is not provided in a direction of a vertical field of view (VFoV).

Example B03 includes the optical system of examples B01-B02 and/or some other example(s) herein, wherein the at least one rotationally asymmetric optical surface is configured to form a curved virtual image surface (VIS) based on the light rays propagating from the PGU.

Example B04 includes the optical system of example B03 and/or some other example(s) herein, wherein an apex of the curved VIS is oriented towards an observer.

Example B05 includes the optical system of examples B03-B04 and/or some other example(s) herein, wherein the VIS has a cylindrical shape with a convex side of the cylindrical shape oriented towards an observer.

Example B06 includes the optical system of example B05 and/or some other example(s) herein, wherein a directrix of the curved VIS is a continuous curved line located along a direction of the HFoV.

Example B07 includes the optical system of examples B01-B06 and/or some other example(s) herein, wherein a directrix of the curved VIS is a continuous curved line located along a direction of the HFoV.

Example B08 includes the optical system of examples B01-B07 and/or some other example(s) herein, wherein the monotonically increasing optical path length monotonically increases from a center point of a field of view (FoV) in a direction of the HFoV.

Example B09 includes the optical system of examples B01-B08 and/or some other example(s) herein, wherein a first angle between a first chief ray and a normal to the VIS is smaller than a second angle between a second chief ray and the normal to the VIS, wherein the first chief ray is closer to a center of an FoV than the second chief ray, and both the first and second chief rays are aimed along a direction of the HFoV.

Example B10 includes the optical system of examples B01-B09 and/or some other example(s) herein, wherein the correction optics assembly comprises at least one optical element, wherein the at least one optical element includes a plurality of surfaces.

Example B11 includes the optical system of example B10 and/or some other example(s) herein, wherein the at least one optical element is formed into a three-dimensional shape selected from a group consisting of planar, sphere, asphere, prism, pyramid, ellipsis, cone, cylinder, toroid, or a combination of any two or more shapes from a group consisting of planar, sphere, asphere, prism, pyramid, ellipsis, cone, cylinder, toroid.

Example B12 includes the optical system of examples B10-B11 and/or some other example(s) herein, wherein the plurality of surfaces includes at least two refractive surfaces and at least one reflective surface.

Example B13 includes the optical system of example B12 and/or some other example(s) herein, wherein the at least one rotationally asymmetric optical surface is one of the at least two refractive surfaces.

Example B14 includes the optical system of examples B12-B13 and/or some other example(s) herein, wherein the at least one reflective surface is disposed between individual refractive surfaces of the at least two refractive surfaces.

Example B15 includes the optical system of example B14 and/or some other example(s) herein, wherein a first surface of the at least two refractive surfaces is a spherical surface, an aspherical surface, an anamorphic surface, or a freeform surface; and a second surface of the at least two refractive surfaces is a spherical surface, an aspherical surface, an anamorphic surface, or a freeform surface.

Example B16 includes the optical system of examples B14-B15 and/or some other example(s) herein, wherein each of the at least two refractive surfaces is a freeform optical surface and the at least one reflective surface is a planar optical surface.

Example B17 includes the optical system of example B16 and/or some other example(s) herein, wherein the freeform surface is formed based on a function selected from a group consisting of radial basis function, basis spline, non-uniform rational basis spline, orthogonal polynomial, non-orthogonal polynomial, hybrid stitched representations based on a combination of two or more functions selected from a group consisting of radial basis function, basis spline, non-uniform rational basis spline, orthogonal polynomial, non-orthogonal polynomial.

Example B18 includes the optical system of examples B12-B17 and/or some other example(s) herein, wherein the at least one rotationally asymmetric optical surface is oriented to face the combiner.

Example B19 includes the optical system of examples B12-B18 and/or some other example(s) herein, wherein the at least one optical element is a prism.

Example B20 includes the optical system of example B19 and/or some other example(s) herein, wherein the correction optics assembly further comprises a lens disposed between the prism and the PGU.

Example B21 includes the optical system of example B20 and/or some other example(s) herein, wherein the lens comprises at least two cylindrical optical surfaces.

Example B22 includes the optical system of example B21 and/or some other example(s) herein, wherein the lens comprises a concave surface oriented towards the PGU.

Example B23 includes the optical system of examples B21-B22 and/or some other example(s) herein, wherein the lens is a telecentering lens.

Example B24 includes the optical system of examples B01-B23 and/or some other example(s) herein, wherein the correction optics assembly comprises one or more of one or more lens, one or more prisms, one or more prismatic lens, one or more mirrors, and one or more holographic optical elements.

Example B25 includes the optical system of example B24 and/or some other example(s) herein, wherein the correction optics assembly further comprises a diffusing element on to which the light rays are projected by the PGU, wherein the diffusing element comprises one or more of a diffusion screen, a diffuser plate, a scattering surface, or an array of microlenses.

Example B26 includes the optical system of examples B01-B25 and/or some other example(s) herein, wherein the combiner comprises a holographic optical element (HOE) with a positive optical power.

Example B27 includes the optical system of example B26 and/or some other example(s) herein, wherein the optical power of the HOE is between 1.1 and 6.6 diopters.

Example B28 includes the optical system of example B27 and/or some other example(s) herein, wherein the optical power of the HOE is between 2.85 diopters.

Example B29 includes the optical system of example B28 and/or some other example(s) herein, wherein the HOE has a focal length of 350 millimeters (mm).

Example B30 includes the optical system of examples B01-B29 and/or some other example(s) herein, wherein the PGU is communicatively coupled with an in-vehicle computing system, and the PGU is configured to generate the light rays based on signals obtained from the in-vehicle computing system, wherein the light rays are representative of one or more three-dimensional (3D) virtual images.

Example B31 includes the optical system of examples B01-B30 and/or some other example(s) herein, wherein the optical system is, or is included in an Augmented Reality (AR) Head-up Display (HUD) device.

Example C01 includes an optical system, comprising: a combiner; a picture generation unit (PGU) configured to project light rays towards the combiner; and a correction optics assembly disposed between the PGU and the combiner, wherein the correction optics assembly comprises at least one rotationally asymmetric optical surface arranged to form a virtual image surface (VIS) with its apex oriented towards an observer by producing an optical path with a monotonically increasing optical path length from the apex in a direction of a horizontal field of view (HFoV) from light rays propagating from the PGU to the combiner via the correction optics assembly such that a stereoscopic depth of field (SDoF) is provided by the optical system to display virtual objects at different distances from an observer.

Example C02 includes the optical system of example C01 and/or some other example(s) herein, wherein the monotonically increasing optical path length monotonically increases from a center point of a field of view (FoV) in a direction of the HFoV.

Example C03 includes the optical system of example C02 and/or some other example(s) herein, wherein a first angle between a first chief ray and a normal to the VIS is smaller than a second angle between a second chief ray and the normal to the VIS, wherein the first chief ray is closer to a center of the FoV than the second chief ray, and both the first and second chief rays are aimed along a direction of the HFoV.

Example C04 includes the optical system of example C03 and/or some other example(s) herein, wherein the optical system displays virtual objects at different distances from the observer in accordance with natural perspective.

Example C05 includes the optical system of examples C01-C04 and/or some other example(s) herein, wherein the VIS has a cylindrical shape with a convex side of the cylindrical shape oriented towards the observer.

Example C06 includes the optical system of example C05 and/or some other example(s) herein, wherein the VIS has a directrix which is a continuous curved line located along a direction of the HFoV.

Example C07 includes the optical system of example C05 and/or some other example(s) herein, wherein the VIS has a directrix which is a continuous curved line extending lineally in a direction of the HFoV.

Example C08 includes the optical system of examples C01-C07 and/or some other example(s) herein, wherein the combiner comprises a holographic optical element (HOE) with a positive optical power.

Example C09 includes the optical system of example C08 and/or some other example(s) herein, wherein the optical power of the HOE is between 1.1 and 6.6 diopters.

Example C10 includes the optical system of examples C01-C09 and/or some other example(s) herein, wherein the correction optics assembly comprises at least one optical element, and the at least one optical element includes a plurality of surfaces.

Example C11 includes the optical system of example C10 and/or some other example(s) herein, wherein the plurality of surfaces is formed into a three-dimensional shape comprising the at least one rotationally asymmetric optical surface and one or more additional optical surfaces, wherein individual additional optical surfaces of the one or more additional optical surfaces is selected from a group consisting of planar, sphere, asphere, cylinder, toroid, biconic, freeform.

Example C12 includes the optical system of example C10 and/or some other example(s) herein, wherein the plurality of surfaces is formed into a three-dimensional shape comprising the at least one rotationally asymmetric optical surface and one or more additional optical surfaces, wherein individual additional optical surfaces of the one or more additional optical surfaces is a planar surface, a spherical surface, an aspherical surface, a cylindrical surface, a toroidal surface, a biconic surface, or a freeform surface.

Example C13 includes the optical system of example C10-C12 and/or some other example(s) herein, wherein the plurality of surfaces includes at least two refractive optical surfaces and at least one reflective optical surface, and the at least one optical element is formed such that the at least one reflective optical surface is disposed between individual refractive optical surfaces of the at least two refractive optical surfaces.

Example C14 includes the optical system of example C13 and/or some other example(s) herein, wherein the at least one rotationally asymmetric optical surface is one of the at least two refractive optical surfaces.

Example C15 includes the optical system of examples C13-C14 and/or some other example(s) herein, wherein the at least one optical element is a prism.

Example C16 includes the optical system of examples C13-C15 and/or some other example(s) herein, wherein a first surface of the at least two refractive optical surfaces is a spherical surface, an aspherical surface, a biconic surface or a freeform surface; and a second surface of the at least two refractive optical surfaces is a spherical surface, an aspherical surface, a biconic surface, or a freeform surface.

Example C17 includes the optical system of examples C13-C16 and/or some other example(s) herein, wherein the at least one reflective optical surface is a spherical surface, an aspherical surface, a biconic surface or a freeform surface.

Example C18 includes the optical system of examples C13-C17 and/or some other example(s) herein, wherein each of the at least two refractive optical surfaces is a freeform optical surface and the at least one reflective optical surface is a planar optical surface.

Example C19 includes the optical system of examples C10-C18 and/or some other example(s) herein, wherein the correction optics assembly further comprises one or more additional optical elements, wherein the one or more additional optical elements includes one or more of lenses, filters, prisms, mirrors, beam splitters, diffusers, diffraction gratings, and multivariate optical elements.

Example C20 includes the optical system of examples C01-C19 and/or some other example(s) herein, wherein the optical system is, or is included in an Augmented Reality (AR) Head-up Display (HUD) device with improved visual ergonomics.

Example D01 includes an optical system of an augmented reality (AR) head-up display (HUD) device with improved visual ergonomics, the optical system comprising: a combiner including a holographic optical element (HOE) with positive optical power; a picture generation unit (PGU) configured to project light rays towards the combiner; and a correction optics assembly disposed between the PGU and the combiner, wherein the correction optics assembly comprises at least one rotationally asymmetric optical surface arranged to provide a stereoscopic depth of field (SDoF) by producing a monotonically increasing optical path along a horizontal field of view (HFoV) from the light rays propagating from the PGU to the combiner such that the optical system displays virtual objects at different distances from an observer.

Example D02 includes the optical system of example D01 and/or some other example(s) herein, wherein the monotonically increasing optical path monotonically increases from a center point of a field of view (FoV) in a direction of the HFoV.

Example D03 includes the optical system of examples D01-D02 and/or some other example(s) herein, wherein the at least one rotationally asymmetric optical surface is configured to form a curved virtual image surface (VIS) based on the light rays propagating from the PGU, and wherein the curved VIS has a cylindrical shape, an apex of the curved VIS is oriented towards the observer, and a directrix of the curved VIS is a continuous curved line extending in a direction of a horizontal field of view (HFoV).

Example D04 includes the optical system of example D03 and/or some other example(s) herein, wherein the correction optics assembly comprises at least one optical element, and the at least one optical element includes at least two refractive optical surfaces and at least one reflective optical surface.

Example D05 includes the optical system of example D04 and/or some other example(s) herein, wherein the at least one optical element is formed to have a prismatic shape, and the at least one reflective optical surface is disposed between individual refractive optical surfaces of the at least two refractive optical surfaces.

Example D06 includes the optical system of examples D04-D05 and/or some other example(s) herein, wherein the at least one rotationally asymmetric optical surface is one of the at least two refractive optical surfaces, and another one of the at least two refractive optical surfaces is one of a flat or planar surface, a spherical surface, an aspherical surface, a cylindrical surface, a toroidal surface, a biconic surface, or a freeform surface, and wherein the at least one reflective optical surface is one of a planar surface, a spherical surface, an aspherical surface, a cylinder surface or cylindrical surface, a toroid surface, a biconic surface or a freeform surface.

Example D07 includes the optical system of examples D04-D06 and/or some other example(s) herein, wherein each of the at least two refractive optical surfaces is a freeform optical surface and the at least one reflective optical surface is a planar optical surface.

Example E01 includes an optical system of augmented reality head-up display device with improved visual ergonomics, comprising: combiner means for displaying one or more virtual objects; picture generation means for projecting light rays representative of the one or more virtual objects towards the combiner means; and correction optics means disposed between the picture generation means and the combiner means, wherein the correction optics means is for forming virtual image surface (VIS) with its apex oriented towards an observer by producing an optical path with a monotonically increasing optical path length from the apex in a direction of a horizontal field of view (HFoV) from light rays propagating from the picture generation means to the combiner means such that a stereoscopic depth of field (SDoF) is provided by the optical system to display the one or more virtual objects at different distances from an observer.

Example E02 includes the optical system of example E01 and/or some other example(s) herein, wherein the monotonically increasing optical path length monotonically increases from a center point of a field of view (FoV) in a direction of the HFoV.

Example E03 includes the optical system of example E02 and/or some other example(s) herein, wherein a first angle between a first chief ray and a normal to the VIS is smaller than a second angle between a second chief ray and the normal to the VIS, wherein the first chief ray is closer to a center of the FoV than the second chief ray, and both the first and second chief rays are aimed along a direction of the HFoV.

Example E04 includes the optical system of example E03 and/or some other example(s) herein, wherein the correction optics means is for forming the VIS such that the one or more virtual objects are displayed at different distances from the observer in accordance with natural perspective.

Example E05 includes the optical system of examples E01-E04 and/or some other example(s) herein, wherein the VIS has a cylindrical shape with a convex side of the cylindrical shape oriented towards the observer.

Example E06 includes the optical system of example E05 and/or some other example(s) herein, wherein the VIS has a directrix which is a continuous curved line located along a direction of the HFoV and/or the directrix which is a continuous curved line extending lineally in the direction of the HFoV.

Example E07 includes the optical system of examples E01-E06 and/or some other example(s) herein, wherein the one or more virtual objects are holographic objects.

Example E08 includes the optical system of examples E01-E07 and/or some other example(s) herein, wherein the correction optics means is the correction optics assembly of any one or more of examples A01-D07, the combiner means is the combiner of any one or more of examples A01-D07, and the picture generation means is the PGU of any one or more of examples A01-D07.

Example F01 includes a computer device communicatively coupled with the AR HUD of any of examples A01-E08, and the computer device is configured to generate one or more signals to control the PGU of any one or more of examples A01-E08.

Example F02 includes one or more computer readable media comprising instructions, wherein execution of the instructions by processor circuitry is to cause a computer device to generate one or more signals to control the PGU of any one or more of examples A01-E08.

Example F03 includes an electromagnetic signal generated as a result of execution of instructions stored by one or more computer readable media, wherein the electromagnetic signal is to cause the PGU of any one or more of examples A01-E08 to generate the light rays representative of the one or more virtual objects of any one or more of examples A01-E08.

### 3. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used with respect to the present disclosure, are synonymous.

The term “anamorphic surface” at least in some embodiments refers to a non-symmetric surface with bi-axial symmetry. The terms “anamorphic element” and/or “anamorphic optical element” refer to an optical element with at least one anamorphic surface and/or an optical element with a combination of spherical, aspherical, and toroidal surfaces.

The term “aperture” at least in some embodiments refers an optically relevant portions of an optical surface. Additionally or alternatively, the term “aperture” at least in some embodiments refers to a hole or an opening through which light travels. Additionally or alternatively, the “aperture” and focal length of an optical system determine the cone angle of a bundle of rays that come to a focus in the image plane.

The term “aperture stop” at least in some embodiments refers to an opening or structure that limits the amount of light which passes through an optical system.

Additionally or alternatively, the term “aperture stop” at least in some embodiments refers to a stop that primarily determines a ray cone angle and brightness at an image point. The term “stop” at least in some embodiments refers to an opening or structure that limits bundles of ray, and may include a diaphragm of an aperture, edges of lenses or mirrors, a fixture that holds an optical element in place, and/or the like.

The term “aspect” at least in some embodiments, depending on the context, refers to an orientation of a slope, which may be measured clockwise in degrees from 0 to 360, where 0 is north-facing, 90 is east-facing, 180 is south-facing, and 270 is west-facing.

The term “augmented reality” or “AR” at least in some embodiments refers to an interactive experience of a real-world environment where the objects that reside in the real-world are “augmented” by computer-generated perceptual information, sometimes across multiple sensory modalities, including visual, auditory, haptic, somatosensory, and olfactory.

The term “chief ray” at least in some embodiments refers to a central ray of a bundle of rays. Additionally or alternatively, the term “chief ray” at least in some embodiments refers to a ray from an off-axis object point that passes through the center of an aperture stop of an optical system. Additionally or alternatively, the term “chief ray” at least in some embodiments refers to a meridional ray that starts at the edge of an object, and passes through the center of an aperture stop. The term “chief light ray” or “chief ray” can also be referred to as a “principal ray” or a “b ray”.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “curvature” at least in some embodiments refers to a rate of change of direction of a curve with respect to distance along the curve.

The term “diffuser” at least in some embodiments refers to any device or material that diffuses or scatters light in some manner. A “diffuser” may include materials that reflect light, translucent materials (e.g., glass, ground glass, reflon/reflow, opal glass, greyed glass, etc.), and/or other materials. The term “diffractive diffuser” at least in some embodiments refers to a diffuser or diffractive optical element (DOE) that exploits the principles of diffraction and refraction. The term “speckle diffuser devices (also referred to as “speckle diffusers”) at least in some embodiments refers to devices used in optics to destroy spatial coherence (or coherence interference) of laser light prior to reflection from a surface.

The term “diopter” at least in some embodiments refers to a unit of refractive power of an optical element.

The term “directrix” at least in some embodiments refers to a curve associated with a process generating a geometric object such as cylindrically shaped surface.

The term “dummy surface” at least in some embodiments refers to a surface that has no refractive effect and/or do not alter the path of rays. Additionally or alternatively, the term “dummy surface” at least in some embodiments refers to a reference in a description of an optical system to indicate where a part will be located when or after the optical system is manufactured; such parts may include, for example mechanical stops, apertures, obscurations, mounts, baffles, and/or some other mechanical part.

The terms “ego” (as in, e.g., “ego device”) and “subject” (as in, e.g., “data subject”) at least in some embodiments refers to an entity, element, device, system, etc., that is under consideration or being considered. The terms “neighbor” and “proximate” (as in, e.g., “proximate device”) at least in some embodiments refers to an entity, element, device, system, etc., other than an ego device or subject device.

The term “element” at least in some embodiments refers to a unit that is indivisible at a given level of abstraction and has a clearly defined boundary, wherein an element may be any type of entity including, for example, one or more devices, systems, controllers, network elements, modules, etc., or combinations thereof.

The term “eye box”, “eye box”, or “eye-box” at least in some embodiments refers to a volume of space from which a virtual image is observable, and representing a combination of exit pupil size and eye relief distance.

The term “fabrication” at least in some embodiments refers to the creation of a metal structure using fabrication means. The term “fabrication means” as used herein refers to any suitable tool or machine that is used during a fabrication process and may involve tools or machines for cutting (e.g., using manual or powered saws, shears, chisels, routers, torches including handheld torches such as oxy-fuel torches or plasma torches, and/or computer numerical control (CNC) cutters including lasers, mill bits, torches, water jets, routers, etc.), bending (e.g., manual, powered, or CNC hammers, pan brakes, press brakes, tube benders, roll benders, specialized machine presses, etc.), assembling (e.g., by welding, soldering, brazing, crimping, coupling with adhesives, riveting, using fasteners, etc.), molding or casting (e.g., die casting, centrifugal casting, injection molding, extrusion molding, matrix molding, three-dimensional (3D) printing techniques including fused deposition modeling, selective laser melting, selective laser sintering, composite filament fabrication, fused filament fabrication, stereolithography, directed energy deposition, electron beam freeform fabrication, etc.), and PCB and/or semiconductor manufacturing techniques (e.g., silk-screen printing, photolithography, photoengraving, PCB milling, laser resist ablation, laser etching, plasma exposure, atomic layer deposition (ALD), molecular layer deposition (MLD), chemical vapor deposition (CVD), rapid thermal processing (RTP), and/or the like).

The term “field of view” or “FoV” at least in some embodiments refers to an extent of an observable or viewable area or region at a particular position and orientation in space and/or at a given moment. Additionally or alternatively, the term “field of view” or “FoV” at least in some embodiments refers to an angular size of a view cone (e.g., an angle of view). Additionally or alternatively, the term “field of view” or “FoV” at least in some embodiments refers to an angle of view that can be seen through an optical system.

The term “focal length” at least in some embodiments refers to a measure of how strongly an optical system or optical device converges or diverges light Additionally or alternatively, the term “focal length” at least in some embodiments refers to the inverse of an optical power of an optical system.

The term “focal plane” at least in some embodiments refers to a plane that passes through a focal point.

The term “focal point” at least in some embodiments refers to a point to which parallel input rays are concentrated by an optical system or optical element.

The term “focus” at least in some embodiments refers to a point where light rays originating from a point on the object converge. In some embodiments, the term “focus” may be referred to as a “principal focus”, a “focal point”, or an “image point”.

The term “freeform optical element” and/or “FOE” at least in some embodiments refers to an optical element with at least one freeform surface. Additionally or alternatively, the term “freeform optical element” and/or “FOE” at least in some embodiments refers to an optical element that has no translational or rotational symmetry about axes normal to the mean plane. Additionally or alternatively, the term “freeform optical element” and/or “FOE” at least in some embodiments refers to an optical element with specially shaped surface(s) that refract an incident light beam in a predetermined way. In contrast to diffractive optical elements (DOEs), the FOE surface structure is smooth, without abrupt height jumps or high-frequency modulations. Similar to classical lenses, FOEs affect a light beam by refraction at their curved surface structures. FOE refraction behavior is determined by geometrical optics (e.g., ray tracing), in contrast to DOEs, which are described by a wave optical model. Various aspects of freeform optics are discussed in Rolland et al., “Freeform optics for imaging,” Optica, vol. 8, pp. 161-176 (2021), which is hereby incorporated by reference in its entirety.

The term “freeform surface” at least in some embodiments refers to a geometric element that does not have rigid radial dimensions. Additionally or alternatively, the term “freeform surface” at least in some embodiments refers to a surface with no axis of rotational invariance. Additionally or alternatively, the term “freeform surface” at least in some embodiments refers to a non-symmetric surface whose asymmetry goes beyond bi-axial symmetry, spheres, rotationally symmetric aspheres, off-axis conics, toroids and biconics. Additionally or alternatively, the term “freeform surface” at least in some embodiments refers to a freeform surface may be identified by a comatic-shape component or higher-order rotationally variant terms of the orthogonal polynomial pyramids (or equivalents thereof). Additionally or alternatively, the term “freeform surface” at least in some embodiments refers to a specially shaped surface that refracts an incident light beam in a predetermined way. Freeform surfaces have more degrees of freedom in comparison with rotationally symmetric surfaces.

The term “front focal point” at least in some embodiments refers to any light ray that passes through an optical element or optical system and emerges from the optical element/system parallel to the optical axis.

The term “holographic optical element” or “HOE” at least in some embodiments refers to an optical component (e.g., mirrors, lenses, filters, beam splitters, directional diffusers, diffraction gratings, etc.) that produces holographic images using holographic imaging processes or principles, such as the principles of diffraction. The shape and structure of an HOE is dependent on the piece of hardware it is needed for, and the coupled wave theory is a common tool used to calculate the diffraction efficiency or grating volume that helps with the design of an HOE.

The term “laser” at least in some embodiments refers to light amplification by stimulated emission of radiation. Additionally or alternatively, the term “laser” at least in some embodiments refers to a device that emits light through a process of optical amplification based on stimulated emission of electromagnetic radiation. The term “laser” as used herein may refer to the device that emits laser light, the light produced by such a device, or both.

The term “lateral” at least in some embodiments refers to a geometric term of location or direction extending from side to side. Additionally or alternatively, the term “lateral” at least in some embodiments refers to directions or positions relative to an object spanning the width of a body of the object, relating to the sides of the object, and/or moving in a sideways direction with respect to the object.

The term “lens” at least in some embodiments refers to a transparent substance or material (usually glass) that is used to form an image of an object by focusing rays of light from the object. A lens is usually circular in shape, with two polished surfaces, either or both of which is/are curved and may be either convex (bulging) or concave (depressed). The curves are almost always spherical; i.e., the radius of curvature is constant.

The term “lineal” at least in some embodiments refers to directions or positions relative to an object following along a given path with respect to the object, wherein the shape of the path is straight or not straight (e.g., curved, etc.).

The term “linear” at least in some embodiments refers to directions or positions relative to an object following a straight line with respect to the object, and/or refers to a movement or force that occurs in a straight line rather than in a curve.

The term “longitudinal” at least in some embodiments refers to a geometric term of location or direction extending the length of a body. Additionally or alternatively, the term “longitudinal” at least in some embodiments refers to directions or positions relative to an object spanning the length of a body of the object; relating to the top or bottom of the object, and/or moving in an upwards and/or downwards direction with respect to the object.

The term “marginal ray” at least in some embodiments refers to a ray of light passing through an optical system near the edge of an aperture. Additionally or alternatively, the term “marginal ray” at least in some embodiments refers to a ray in an optical system that starts at the point where an object crosses the optical axis, and touches the edge of an aperture stop of the optical system. The term “marginal ray” can also be referred to as a “marginal axial ray” or simply as a “ray”.

The term “meridional ray” at least in some embodiments refers to a ray that is confined to a plane containing an optical system's optical axis and the object point from which the ray originated. The term “meridional ray” can also be referred to as a “tangential ray”.

The term “mirror” at least in some embodiments refers to a surface of a material or substance that diverts a ray of light according to the law of reflection.

The term “monotonic” or “monotone” at least in some embodiments refers to a variable that either increases or decreases, and/or has no inflection points. Additionally or alternatively, the term “monotonic” or “monotone” at least in some embodiments refers to a first variable that either increases or decreases as a second variable either increases or decreases, respectively (the relationship is not necessarily linear, but there are no changes in direction). Additionally or alternatively, the term “monotonically increasing” refers to a variable that rises consistently, and/or a variable that rises consistently as a second variable increases.

The term “natural perspective” at least in some embodiments refers to a manner of depicting objects as they appear to the human visual systems. Additionally or alternatively, the term “natural perspective” at least in some embodiments refers to a phenomena wherein the more remote objects of a series of objects of equal size will look the smaller in comparison to more immediate objects of the series of objects, and conversely, the nearer will look the larger and the apparent size will diminish in proportion to the distance.

The term “normal” at least in some embodiments refers to a line, ray, or vector that is perpendicular to a given object. The term “normal ray” is the outward-pointing light ray perpendicular to the surface of an optical medium and/or optical element at a given point.

The term “off-axis optical system” at least in some embodiments refers to an optical system in which the optical axis of the aperture is not coincident with the mechanical center of the aperture.

The term “obtain” at least in some embodiments refers to (partial or in full) acts, tasks, operations, etc., of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “object”, in the context of the field of optics, at least in some embodiments refers to a figure or element viewed through or imaged by an optical system, and/or which may be thought of as an aggregation of points. For purposes of the present disclosure, the term “object”, in the context of the field of optics, at least in some embodiments may be the a real or virtual image of an object formed by another optical system.

The term “objective”, in the context of the field of optics, at least in some embodiments refers to an optical component and/or optical element that receives light from an object.

The term “optical aberration” and/or “aberration” at least in some embodiments refers to a property of optical systems and/or optical elements that causes light to be spread out over some region of space rather than focused to a point. An aberration can be defined as a departure of the performance of an optical system from a predicted level of performance (or the predictions of paraxial optics).

The term “optical axis” at least in some embodiments refers to a line along which there is some degree of rotational symmetry in an optical system. Additionally or alternatively, the term “optical axis” at least in some embodiments refers to a straight line passing through the geometrical center of an optical element. The path of light ray(s) along the optical axis is perpendicular to the surface(s) of the optical element. The term “optical axis” may also be referred to as a “principal axis”. All other ray paths passing through the optical element and its optical center (the geometrical center of the optical element) may be referred to as “secondary axes”. The optical axis of a lens is a straight line passing through the geometrical center of the lens and joining the two centers of curvature of its surfaces.

The optical axis of a curved mirror passes through the geometric center of the mirror and its center of curvature.

The term “optical element” at least in some embodiments refers to any component, object, substance, and/or material used for, or otherwise related to the genesis and propagation of light, the changes that light undergoes and produces, and/or other phenomena associated with the principles that govern the image-forming properties of various devices that make use of light and/or the nature and properties of light itself. For purposes of the present disclosure, the term “optical element” at least in some embodiments refers to a part of an optical system constructed or formed of a one or more optical materials.

The term “optical power” at least in some embodiments refers to the degree to which an optical element or optical system converges or diverges light. The optical power of an optical element is equal to the reciprocal of the focal length of the device. High optical power corresponds to short focal length. The SI unit for optical power is the inverse meter (m−1), which is commonly referred to as a Diopter (or “Dioptre”). The term “optical power” is sometimes referred to as dioptric power, refractive power, focusing power, or convergence power.

The term “optical path” at least in some embodiments refers to a trajectory that a light ray follows as it propagates through an optical medium.

The term “optical path length” at least in some embodiments refers to a geometric length of an optical path followed by light and a refractive index of the medium through which a light ray propagates. The term “optical path length” may also be referred to as “optical distance”.

The term “optical surface” (or simply “surface”) at least in some embodiments refers to a location, region, or area of interest in an optical system, and which has a particular shape (curvature) and extent (aperture) in space. Additionally or alternatively, the term “optical surface” at least in some embodiments refers to a reflecting or refracting surface that closely approximates a desired geometrical surface.

The term “prism” at least in some embodiments refers to a transparent optical element with flat, polished surface(s) that refract light. Additionally or alternatively, the term “prism” at least in some embodiments refers to a polyhedron comprising an n-sided polygon base, a second base that is a translated copy (rigidly moved without rotation) of the first base, and n other faces joining corresponding sides of the two bases.

The term “rear focal point” or “back focal point” at least in some embodiments refers to any light ray that enters an optical element or optical system parallel to the optical axis and is/are focused such that they pass through a rear focal point

The terms “rotational symmetry” and “radial symmetry” refer to a property of a shape or surface that looks the same after some rotation by a partial turn. An object's degree of rotational symmetry is the number of distinct orientations in which it looks exactly the same for each rotation.

The term “Sagitta” or “sag” at least in some embodiments refers to the height of a curve measured from a chord (i.e., a line segment joining two points on a curve). Additionally or alternatively, the term “Sagitta” or “sag” at least in some embodiments refers to the height or depth of an optical surface such as, for example, the optical surface of a convex or concave lens. Additionally or alternatively, the term “Sagitta” or “sag” at least in some embodiments refers to the perpendicular distance (or displacement) from the vertex of a curve of an optical surface to a plane cutting through the curve of the optical surface.

The term “stereoscopic” or “stereoscopy” at least in some embodiments refers to three-dimensional vision due to the spacing of the eyes, which permits the eyes to see objects, from slight different points of view.

The term “stereoscopic depth of field”, “stereoscopic DoF”, or “SDoF” at least in some embodiments refers to a property or ability of a virtual image to be displayed at different distances within a field of view.

The term “stereoscopic threshold” or “stereothreshold” at least in some embodiments refers to the smallest relative binocular disparity that yields a perception of depth.

The term “slope” at least in some embodiments refers to the steepness or the degree of incline of a surface.

The term “signal” at least in some embodiments refers to an observable change in a quality and/or quantity. Additionally or alternatively, the term “signal” at least in some embodiments refers to a function that conveys information about of an object, event, or phenomenon. Additionally or alternatively, the term “signal” at least in some embodiments refers to any time varying voltage, current, or electromagnetic wave that may or may not carry information. The term “digital signal” at least in some embodiments refers to a signal that is constructed from a discrete set of waveforms of a physical quantity so as to represent a sequence of discrete values.

The term “spherical” at least in some embodiments refers to an object having a shape that is or is substantially similar to a sphere. A “sphere” is a set of all points in three-dimensional space lying the same distance (the radius) from a given point (the center), or the result of rotating a circle about one of its diameters.

The term “substrate” at least in some embodiments refers to a supporting material upon which, or within which, the elements of a semiconductor device are fabricated or attached. Additionally or alternatively, the term “substrate of a film integrated circuit” at least in some embodiments refers to a piece of material forming a supporting base for film circuit elements and possibly additional components. Additionally or alternatively, the term “substrate of a flip chip die” at least in some embodiments refers to a supporting material upon which one or more semiconductor flip chip die are attached. Additionally or alternatively, the term “original substrate” at least in some embodiments refers to an original semiconductor material being processed. The original material may be a layer of semiconductor material cut from a single crystal, a layer of semiconductor material deposited on a supporting base, or the supporting base itself. Additionally or alternatively, the term “remaining substrate” at least in some embodiments refers to the part of the original material that remains essentially unchanged when the device elements are formed upon or within the original material.

The term “surface” at least in some embodiments refers to the outermost or uppermost layer of a physical object or space.

The term “toroidal” at least in some embodiments refers to an object having a shape that is or is substantially similar to a torus. A “torus” is a surface of revolution generated by revolving a circle in three-dimensional space about an axis that is coplanar with the circle.

The term “vergence” at least in some embodiments refers to the angle formed by rays of light that are not perfectly parallel to one another. Additionally or alternatively, the term “vergence” at least in some embodiments refers to the curvature of optical wavefronts. The terms “convergence”, “convergent”, and “converging” refer to light rays that move closer to the optical axis as they propagate. Additionally or alternatively, the terms “convergence”, “convergent”, and “converging” refer to wavefronts propagating toward a single point and/or wavefronts that yield a positive vergence. The terms “divergence”, “divergent”, and “diverging” refer to light rays that move away from the optical axis as they propagate. Additionally or alternatively, the terms “divergence”, “divergent”, and “diverging” refer to wavefronts propagating away from a single source point and/or wavefronts that yield a negative vergence. Typically, convex lenses and concave mirrors cause parallel rays to converge, and concave lenses and convex mirrors cause parallel rays to diverge.

The term “visual ergonomics” at least in some embodiments refers to the theories, knowledge, design, engineering, and/or assessment of systems that involve human visual processes and/or the interactions between human visual processes and other elements of a system. Visual ergonomics usually involves designing, engineering, and/or assessing systems by optimizing human well-being and overall system performance, and may include aspects such as the visual environment (e.g., lighting, etc.), visually demanding work, visual function and performance, visual comfort and safety, optical corrections, and other tasks and/or assistive tools.

The above detailed description refers to the accompanying drawings, which shown, by way of illustration, embodiments that may be practiced. The same reference numbers may be used in different drawings to identify the same or similar elements. Various operations may be described as multiple discrete operations in turn, in a manner that may be helpful in understanding embodiments; however, the order of description should not be construed to imply that these operations are order-dependent. The present disclosure may use perspective-based descriptions such as up/down, back/front, top/bottom, and the like.

Such descriptions are merely used to facilitate the understanding and are not intended to restrict the application to the disclosed embodiments.

The foregoing description of one or more implementations provides illustration and description of various example embodiments, but is not intended to be exhaustive or to limit the scope of embodiments to the precise form disclosed. Modifications and variations are possible in light of the above teachings or may be acquired from practice of various embodiments. Where specific details are set forth in order to describe aspects of the disclosure, it should be apparent to one skilled in the art that the disclosure can be practiced without, or with variation of, these specific details. The description is thus to be regarded as illustrative instead of limiting.

1. An optical system, comprising:
a combiner;
a picture generation unit (PGU) configured to project light rays towards the combiner; and
a correction optics assembly disposed between the PGU and the combiner, wherein the correction optics assembly comprises at least one rotationally asymmetric optical surface arranged to form a virtual image surface (VIS) with its apex oriented towards an observer by producing an optical path with a monotonically increasing optical path length from the apex in a direction of a horizontal field of view (HFoV) from the light rays propagating from the PGU to the combiner via the correction optics assembly such that a stereoscopic depth of field (SDoF) is provided by the optical system to display virtual objects at different distances from the observer.

2. The optical system of claim 1, wherein the monotonically increasing optical path length monotonically increases from a center point of a field of view (FoV) in a direction of the HFoV.

3. The optical system of claim 2, wherein a first angle between a first chief ray and a normal to the VIS is smaller than a second angle between a second chief ray and the normal to the VIS, wherein the first chief ray is closer to a center of the FoV than the second chief ray, and both the first and second chief rays are aimed along the direction of the HFoV.

4. The optical system of claim 1, wherein the VIS has a cylindrical shape with a convex side of the cylindrical shape oriented towards the observer, and the cylindrical shape has a directrix that is a continuous curved line extending in the direction of the HFoV.

5. The optical system of claim 1, wherein the combiner comprises a holographic optical element (HOE) with a positive optical power.

6. The optical system of claim 5, wherein the optical power of the HOE is between 1.1 and 6.6 diopters.

7. The optical system of claim 1, wherein the correction optics assembly comprises at least one optical element, and the at least one optical element includes a plurality of surfaces.

8. The optical system of claim 7, wherein the plurality of surfaces is formed into a three-dimensional shape comprising the at least one rotationally asymmetric optical surface and one or more additional optical surfaces, wherein individual additional optical surfaces of the one or more additional optical surfaces is selected from a group consisting of planar, sphere, asphere, cylinder, toroid, biconic, freeform.

9. The optical system of claim 7, wherein the at least one optical element is a prism, the plurality of surfaces includes at least two refractive optical surfaces and at least one reflective optical surface, and the at least one optical element is formed such that the at least one reflective optical surface is disposed between individual refractive optical surfaces of the at least two refractive optical surfaces.

10. The optical system of claim 9, wherein the at least one rotationally asymmetric optical surface is one of the at least two refractive optical surfaces.

11. The optical system of claim 9, wherein a first surface of the at least two refractive optical surfaces is a spherical surface, an aspherical surface, a biconic surface or a freeform surface; and a second surface of the at least two refractive optical surfaces is a spherical surface, an aspherical surface, a biconic surface, or a freeform surface.

12. The optical system of claim 9, wherein the at least one reflective optical surface is a planar surface, a spherical surface, an aspherical surface, a cylindrical surface, a toroid surface, a biconic surface or a freeform surface.

13. The optical system of claim 9, wherein each of the at least two refractive optical surfaces is a freeform optical surface and the at least one reflective optical surface is a planar optical surface.

14. The optical system of claim 1, wherein the optical system is, or is included in an Augmented Reality (AR) Head-up Display (HUD) device with improved visual ergonomics.

15. An optical system of an augmented reality (AR) head-up display (HUD) device with improved visual ergonomics, the optical system comprising:
a combiner including a holographic optical element (HOE) with positive optical power;
a picture generation unit (PGU) configured to project light rays towards the combiner; and
a correction optics assembly disposed between the PGU and the combiner, wherein the correction optics assembly comprises at least one rotationally asymmetric optical surface arranged to provide a stereoscopic depth of field (SDoF) by producing a monotonically increasing optical path along a horizontal field of view (HFoV) from the light rays propagating from the PGU to the combiner such that the optical system displays virtual objects at different distances from an observer.

16. The optical system of claim 15, wherein the monotonically increasing optical path monotonically increases from a center point of a field of view (FoV) in a direction of the HFoV.

17. The optical system of claim 15, wherein the at least one rotationally asymmetric optical surface is configured to form a curved virtual image surface (VIS) based on the light rays propagating from the PGU, and wherein the curved VIS has a cylindrical shape, an apex of the curved VIS is oriented towards the observer, and a directrix of the curved VIS is a continuous curved line extending in a direction of the HFoV.

18. The optical system of claim 17, wherein the correction optics assembly comprises at least one optical element, and the at least one optical element includes at least two refractive optical surfaces and at least one reflective optical surface.

19. The optical system of claim 18, wherein the at least one optical element is formed to have a prismatic shape, and the at least one reflective optical surface is disposed between individual refractive optical surfaces of the at least two refractive optical surfaces.

20. The optical system of claim 18, wherein the at least one rotationally asymmetric optical surface is one of the at least two refractive optical surfaces, and another one of the at least two refractive optical surfaces is one of a flat or planar surface, a spherical surface, an aspherical surface, a cylindrical surface, a toroidal surface, a biconic surface, or a freeform surface, and wherein the at least one reflective optical surface is one of a planar surface, a spherical surface, an aspherical surface, a cylindrical surface, a toroid surface, a biconic surface or a freeform surface.

21. The optical system of claim 18, wherein each of the at least two refractive optical surfaces is a freeform optical surface and the at least one reflective optical surface is a planar optical surface.
